(19) United States
(12) Patent Application Publication
(10) Pub. No.: US 2025/0384410 A1
(43) Pub. Date: Dec. 18, 2025

(54) PROACTIVE IN-VEHICLE PAYMENT SYSTEM USING SENSOR DATA WITH MACHINE LEARNING

(71) Applicant: Car IQ Inc., San Francisco, CA (US)

(72) Inventors: Ryuji Ishiguro, San Francisco, CA (US); Arun Yadav, Cupertino, CA (US); Sterling Pratz, San Francisco, CA (US)

(21) Appl. No.: 19/034,101

(22) Filed: Jan. 22, 2025

Related U.S. Application Data
(60) Provisional application No. 63/660,280, filed on Jun. 14, 2024.

(51) Int. Cl. G06Q 20/06; G06Q 20/36; G06Q 20/40; G06Q 30/0283; G06V 10/70; G06V 20/56; G07C 5/08; G07C 5/10

(52) U.S. Cl. CPC G06Q 20/06; G06Q 20/36; G06Q 20/4016; G06Q 30/0284; G06V 10/70; G06V 20/588; G07C 5/10; G07C 5/0808

(57) ABSTRACT

Aspects of the present disclosure describe a system comprising a processor and memory storing instructions, which when executed by the processor, enable the system to detect a payment-related event using vehicle sensors, such as a camera or GPS unit. The detection can involve a machine learning model trained to recognize objects associated with the payment-related event while minimizing false positives. Upon detecting the event, the system can handle the electronic payment by utilizing an in-vehicle digital wallet to execute the payment and recording the transaction on a blockchain-based ledger.

### CROSS-REFERENCE TO RELATED APPLICATIONS

This application claims priority to and the benefit of U.S. Provisional Patent Application No. 63/660,280, entitled “PROACTIVE IN-VEHICLE PAYMENT SYSTEM USING SENSOR DATA WITH MACHINE LEARNING,” filed on Jun. 14, 2024, which is incorporated herein by reference in its entirety.

### TECHNICAL FIELD

The present disclosure relates generally to transaction systems and, more specifically, to the field of autonomous transaction (e.g., electronic payment) technologies that integrate one or more of machine learning, in-vehicle sensor data processing, and cryptographic security measures to facilitate proactive and automated transactions (e.g., electronic financial transactions) directly from a vehicle or an Internet of Things (IoT) device.

### BACKGROUND

Traditional payment systems like credit cards and mobile payments generally require user involvement and are influenced by user intent, especially in non-retail transactions. Users often prefer passive engagement in the payment process, particularly when accessing services like parking or express lanes without direct payment.

### BRIEF DESCRIPTION OF THE SEVERAL VIEWS OF THE DRAWINGS

The disclosure will be understood more fully from the detailed description given below and from the accompanying drawings of various example embodiments of the disclosure. The detailed description includes systems, methods, techniques, instruction sequences, or computing machine program products that embody illustrative example embodiments of the disclosure. In the following description, for the purposes of explanation, numerous specific details are set forth in order to provide an understanding of various example embodiments of the inventive subject matter. It will be evident, however, to those skilled in the art, that example embodiments of the inventive subject matter may be practiced without these specific details. In general, well-known instruction instances, protocols, structures, and techniques are not necessarily shown in detail. To easily identify the discussion of any particular element or act, the most significant digit or digits in a reference number refer to the figure number in which that element is first introduced. Some non-limiting examples are illustrated in the figures of the accompanying drawings.

FIG. 1 is a diagrammatic representation of an example in-vehicle transaction system in a networked environment in which the present disclosure may be deployed, in accordance with some example embodiments of the present disclosure.

FIG. 2 through FIG. 6 illustrate details for implementing certain features, in accordance with some example embodiments of the present disclosure.

FIG. 7 is a block diagram illustrating an example implementation of an in-vehicle transaction system, in accordance with some example embodiments of the present disclosure.

FIG. 8 is a schematic representation of an example roadway with which an in-vehicle transaction system can operate, in accordance with some example embodiments of the present disclosure.

FIG. 9 presents a schematic representation of two vehicles with which an in-vehicle transaction system can operate, in accordance with some example embodiments of the present disclosure.

FIG. 10 outlines a flowchart describing an example method for automated payment when a system of a vehicle detects a tollgate or a road sign associated with a toll gate, in accordance with some example embodiments of the present disclosure.

FIG. 11 is a flowchart illustrating an example of how a prepaid scenario can be processed by a system, in accordance with some example embodiments of the present disclosure.

FIG. 12 is a flowchart illustrating an example of how a transaction can be processed by a system, in accordance with some example embodiments of the present disclosure.

FIG. 13 is a graph illustrating an example of how a balance-based ledger can be used by a system, in accordance with some example embodiments of the present disclosure.

FIG. 14 is a graph illustrating an example of how an electronic transaction can be processed by a system, in accordance with some example embodiments of the present disclosure.

FIG. 15 is a diagram illustrating an example of how to implement auditable, tamper-evidence proofs that can be used by a system, in accordance with some example embodiments of the present disclosure.

FIG. 16 through FIG. 18 illustrate examples of how an in-vehicle digital wallet can be used by a system, in accordance with some example embodiments of the present disclosure.

FIG. 19 is a flowchart illustrating example method for facilitating automated transactions from a vehicle based on a set of vehicle sensors, in accordance with some example embodiments of the present disclosure.

FIG. 20 is a diagrammatic representation of a machine in the form of a computer system within which a set of instructions may be executed for causing the machine to perform any one or more of the methodologies discussed herein, in accordance with some example embodiments of the present disclosure.

FIG. 21 is a block diagram showing a software architecture within which examples may be implemented.

### DETAILED DESCRIPTION

The description that follows includes systems, methods, techniques, instruction sequences, and computing machine program products that embody illustrative example embodiments of the disclosure. In the following description, for the purposes of explanation, numerous specific details are set forth in order to provide an understanding of various example embodiments of the inventive subject matter. It will be evident, however, to those skilled in the art, that example embodiments of the inventive subject matter may be practiced without these specific details. In general, well-known instruction instances, protocols, structures, and techniques are not necessarily shown in detail.

Wireless technologies like Electronic Toll Collection (ETC) and FasTrack® have facilitated the ease of passing through toll gates without causing traffic congestion. Additionally, authorities have installed transponder antennas to levy extra fees for the use of express lanes.

Unfortunately, the cost of establishing such infrastructure is substantial for authorities, and there is also a financial burden on drivers who must purchase and install ETC units. Detecting evasions such as tailgating at toll gates, circumventing roadside cameras by erratic driving, and violations of High Occupancy Vehicle (HOV) lane regulations remains challenging. The responsibility to identify such infractions predominantly falls on law enforcement agencies. With ETC systems implemented at gates, there is a limitation in monitoring each vehicle's movement along highways, which restricts the system's ability to impose additional charges for driving in specific zones or lanes.

Another significant challenge is the financial implication of issuing bills, which represents a considerable administrative expense. Additionally, drivers face inconveniences in managing toll fees due to the non-real-time nature of charges, which are accumulated and billed subsequently.

Law enforcement also encounters difficulties in real-time detection of traffic violations such as HOV breaches and speeding, owing to the lack of instantaneous and reliable evidence. Furthermore, prospective buyers of pre-owned vehicles often lack crucial information on the vehicle's history, such as the frequency of rapid charging sessions, which can significantly affect battery life.

Lastly, consistent connectivity poses a challenge for device operation, especially for vehicles. Conventional payment systems depend on an internet connection to process payments; however, scenarios such as entering an express lane or passing tollgates frequently occur during connectivity outages, complicating the payment process and tracking of vehicular movements.

Various example embodiments described herein overcome a number of challenges identified in conventional transaction (e.g., payment) systems and aim to address the issues described above. In particular, various examples described herein provide a system designed to enhance the efficiency and reliability of automated transaction (e.g., payment) systems in various vehicular and infrastructural contexts. Various example embodiments described herein innovatively combine aspects of artificial intelligence, specifically applied machine learning, with real-time data acquisition and processing technologies, such as those employed in smart vehicles and IoT systems, to autonomously detect and process transaction-related (e.g., payment-related) events. Some example embodiments use blockchain technology to ensure integrity and security of transactions, and to implement electronic financial technology and cybersecurity within automotive technologies.

Furthermore, some example embodiments offer unique solutions for traffic and vehicle management, which can include handling toll gate payments, parking fees, and traffic violation fines through autonomous and seamless transactions (e.g., electronic financial transactions) without human intervention. Some example embodiments integrate use of in-machine digital wallet technology (e.g., as an in-vehicle digital wallet) for managing one or more electronic financial transactions, maintaining vehicle use records, or both. The in-machine digital wallet technology can enable smart contract applications in the context of vehicle applications.

Some example embodiments provide a transaction system integrated within machines, such as vehicles and IoT devices, and designed to not only automate but also autonomously and proactively handle transactions (e.g., electronic payments) for a variety of events (e.g., events associated with a charge or a fee), such as traveling through toll gates, parking, subscriptions for enhanced features, and violation fines (e.g., for traffic infractions).

With respect to toll fees, a system of various example embodiments uses one or more in-car sensors, including cameras, GPS, meter readings, and the like, to accurately detect and manage toll payments. For instance, Express Lanes can be identified using visual data from in-car cameras. Occupancy for High Occupancy Vehicle (HOV) lanes can be verified by detecting the number of passengers through the seat sensors and inside camera footage. Tollgates can be recognized via GPS coordinates, supported by object recognition technologies using in-car cameras. Machine learning models can help reduce false positives and can be tailored specifically for each location to handle unique environmental variables.

With respect to vehicle parking fees, a system of various example embodiments handles payments for parking autonomously using GPS to pinpoint the exact parking location and cameras to confirm the vehicle's presence in a parking space (e.g., parking spot). Additional sensor data, such as gear position, parking brake status, and speedometer readings, can be used to determine the exact times the vehicle is parked, enabling some example embodiments to determine precise charges for the duration parked.

With respect to vehicle feature subscription fees, a system of various example embodiments handles automatic billing for optional vehicle features, such as fast charging for a vehicle and seat heating within a vehicle, based on usage monitored by the vehicle's integrated sensors.

With respect to traffic violation fines, a system of various example embodiments processes and bills potential traffic violations, with the system identifying infractions like speeding or illegal lane changes based on comprehensive sensor data. The same sensor data can be potentially used to contest false accusations.

With respect to in-machine wallet technology, a system of various example embodiments use an in-machine wallet that performs one or more several critical functions. The system can allow for recording negative balances for instances where immediate payment is not possible, either due to insufficient funds or lack of internet connectivity. The system can log detailed histories of charging, repairs, and other key activities to aid transparency for potential future owners of a vehicle. The system can securely store sensor data and object detection results, which can serve as evidence to prevent or contest false accusations or unlawful activities. Additionally, the system can keep records of usage data for subscribed features, ensuring accurate billing and service tracking.

With respect to security and transparency, a system of various example embodiments records one or more transactions and activities in a confidential blockchain-based ledger. The blockchain-based ledger can comprise one or more proofs of activities linked to one or more electronic financial transactions to ensure integrity and transparency. According to some example embodiments, when a vehicle changes ownership, the new owner can verify all logged activities without access to the previous owner's personal details, ensuring privacy and trust in the vehicle's history.

With respect to tamper-proof storage, a system of various example embodiments uses an in-machine wallet that comprises a tamper-proof storage system, which ensures the security and integrity of data. Depending on the example embodiment, this can be achieved through one or more different mechanisms. For example, the in-vehicle digital wallet can be implemented using Oblivious Pseudo-Random Function (PRF), which can generate a master key of the secure storage. This cryptographic protocol can ensure that neither the client nor the server can deduce the other's inputs while still allowing the computation of the PRF. The cryptographic protocol can guarantee that the master key remains confidential and can only be produced by authorized parties, providing a robust defense against unauthorized access or manipulation. In another instance, the in-vehicle digital wallet can be implemented using a secure computation environment, such as Arm® TrustZone®, which can provide an isolated execution space that separates secure operations from the regular operating environment of the vehicle's computing system. This secure zone can ensure that sensitive operations related to payment processing and key management are protected from potential threats that could compromise the system. In yet another instance, the in-vehicle digital wallet can be implemented using a hardware chip (e.g., secure element), which can be a dedicated hardware chip that can be embedded within the system. Such a chip can offer fortified storage and processing capabilities for cryptographic operations, further bolstering the in-vehicle digital wallet's defenses against physical tampering and software-based attacks.

With respect to privacy-preserving sensor data authorization methodologies, to maintain privacy and resist tampering with sensor data, a system of various example embodiments can comprise a sensor data authorization component (e.g., module) that uses one or more statistical models. The component can implement cumulative correlation, where the component can compute the cumulative correlation of location and multiple sensor data inputs, such as speedometer and odometer readings. The component can use coskewness as a statistical measure to evaluate the skewed relationships among these data points over time, enhancing the system's ability to detect and prevent fraudulent activities. Additionally, or alternatively, the component can implement trend analysis. For example, by analyzing the trend of distance traveled using Kendall's tau, a system of some example embodiments can determine a measure of the ordinal association between two measured quantities, and validate the consistency and reliability of sensor data. In this way, various example embodiments can assist in identifying any anomalies or discrepancies that may indicate tampering or sensor failure. More with respect to cumulative correlation and trend analysis are described below.

Regarding cumulative correlation, some example embodiments read (e.g., collect information from) data from at least three independent sensors every t seconds: GPS location data, speed meter data; and Odometer data. Based on the data, some example embodiments calculate:

$${Δ}_{{loc}_{i}} = Haversine ( {loc}_{i - 1} ) ; \qquad Equation 1$$

$${Δ}_{s p {d}_{i}} = Average \{ {speed}_{i} \} ) ( {t}_{i} - {t}_{i - j} ) ; \qquad Equation 2$$

$${Δ}_{o d {o}_{i}} = o d {o}_{i} - o d {o}_{i - 1} . \qquad Equation 3$$

Some example embodiments determine the vector of relative locations from the independent sources, as follows.

$${δ}_{i} = [ \begin{matrix}{Δ}_{l o {c}_{i}} \\ {Δ}_{s p {d}_{i}} \\ {Δ}_{o d {o}_{i}}\end{matrix} ] , \qquad Equation 4$$

Thereafter, some example embodiments cumulatively calculate the standard deviation and covariance on every sampling event as follows.

$${μ}_{n} = \frac{( n - 1 ) {μ}_{n - 1} + {δ}_{n}}{n} \qquad Equation 5$$

$${σ}_{n}^{2} = \frac{n - 1}{n} ( {σ}_{n - 1}^{2} + \frac{{( {μ}_{n - 1} - {δ}_{n} )}^{2}}{n} ) \qquad Equation 6$$

$${δ}_{n}^{+} = {δ}_{n - 1}^{+} + {δ}_{n} \qquad Equation 7$$

$${a}_{n} = {a}_{n - 1} + {δ}_{n , 1} {δ}_{n , 2} {δ}_{n , 3} \qquad Equation 8$$

$${𝓍}_{n} = {𝓍}_{n - 1} + {δ}_{n , 1} {δ}_{n , 2} \qquad Equation 9$$

$${𝓎}_{n} = {𝓎}_{n - 1} + {δ}_{n , 2} {δ}_{n , 3} \qquad Equation 10$$

$${𝓏}_{n} = {𝓏}_{n - 1} + {δ}_{n , 1} {δ}_{n , 3} \qquad Equation 11$$

Some example embodiments then set the parameter as follows.

$$X = \{ {μ}_{n} , {σ}_{n}^{2} , {C}_{n} , n , {\{ {δ}_{n , 2} \}}_{i ∈ ℛ} \} , where {C}_{n} = \frac{{a}_{n} - ( {δ}_{n 3}^{+} , {𝓍}_{n} + {𝓎}_{n} + {𝓏}_{n} ) / n + 2 n {μ}_{n , 1} {μ}_{n , 1} {μ}_{n , 2} {μ}_{n , 3}}{n} . \qquad Equation 12$$

{δᵢ} is a randomly chosen subset of the random variables. These parameters can be cumulatively calculated in a vehicle until the wallet is reset.

Some example embodiments use an evaluation function to calculate the coskewness with the current correlation coefficients (X1.{μ}, X1.δ) and the new random variables (X2.{δ}) as follows.

$${r}_{1} = S ( \{ {X}_{2} . δ \} ; {X}_{1} . μ , {X}_{1} . σ ) = \frac{E [ ( {X}_{2} . {δ}_{1} - {X}_{1} . {μ}_{1} ) ( {X}_{2} . {δ}_{2} - {X}_{1} . {μ}_{2} ) ( {X}_{2} . {δ}_{3} - {X}_{1} . {μ}_{3} ) ]}{{X}_{1} . {σ}_{1} {X}_{1} . {σ}_{2} {X}_{1} . {σ}_{3}} \qquad Equation 13$$

This can be compared to:

$${r}_{2} = \frac{{x}_{2} . C}{{X}_{2} . {σ}_{1} {X}_{2} . {σ}_{2} {X}_{2} . {σ}_{3}} \qquad Equation 14$$

Some example embodiments determine an output as the difference: |r₁−r₂|.

The time interval can depend on the limitations of the platform. For example, the time interval can be 1≤t≤3. Some example embodiments achieve the statistical authentication using a large number of samples for accuracy (given that sensor readings can be noisy and inaccurate at times). The granularity of sampled data can vary between different example embodiments. For some example embodiments, cumulative correlation coefficients level out automatically over time. Additionally, for some example embodiments, the sampling rate is as small as possible to accumulate more data.

According to various example embodiments, cumulative correlation coefficients are used as a unique “fingerprint” of a vehicle. To prove that a (new) transaction comes from the same vehicle, some example embodiments emulate the vehicle with the correlation coefficients stored in the ledger and newly sampled random variables. If the correlation calculated by the ledger and the cumulative correlation the vehicle currently has are matched, it will raise the confidence level of the received transaction.

Regarding trend analysis with anchor points, some example embodiments assume a payment can happen at specific locations, such as gas stations, parking lots, tolling gates, and the like. Various example embodiments use this as an advantage from a security point of view and use these locations to authenticate the vehicle data. For example, even if the vehicle is hacked, attackers cannot do anything about the payment locations that come from third-party oracles.

Various example embodiments perform anomaly detection by detecting a trend in a time series of locations of a vehicle. For example, with distances from the latest payment location (e.g., dᵢ=Haversine(loc₀, locᵢ), where loc₀ is an anchor location) in time series (i=1 . . . n), monotonic trend using Kendall's τ can be calculated as:

$$τ = \frac{2}{n ( n - 1 )} {\sum }_{i = 1}^{n - 1} {\sum }_{j = i + 1}^{n} sgn ( {d}_{j} - {d}_{j} ) , \qquad Equation 15$$

where sgn(x)={1, 0, −1} according to the sign of x.

τ can be seen as a factor of how far a given vehicle tends to be from the last payment location. The higher the value of τ is the more likely the vehicle is far from the anchor location. If the distance between the current payment location and the last one is far greater than what the trend tells us, various example embodiments can suspect this to be a fraud. For instance, where τ≈0 with respect to a given transaction (which can mean the vehicle has been circled around the location), but the current location is as far as 1000 km away, various example embodiments can flag the given transaction as an anomaly. For some example embodiments, τ will smooth out outliers that might be caused by signal noise, hardware glitch, and software bugs. If it is temporary they should not be significant factors.

According to various example embodiments, to authenticate a vehicle, a system follows the standard commitment—challenge—response protocol: Commitment (τ) from vehicle to blockchain-based ledger; Challenge ({locᵢ}) from blockchain-based ledger to vehicle; and from vehicle blockchain-based ledger. The vehicle sends the current t to the ledger. The ledger retrieves the payment location from the oracle and sends it back to the vehicle with dummy locations. The vehicle adds the location one by one and re-calculates the corresponding

$${τ}_{i}^{′} .$$

The parameter set is

$$X = \{ τ , \{ {τ}_{i}^{′} , {loc}_{i} \} \} .$$

The evaluation function checks if the deviation of each

$$( {loc}_{i} , {τ}_{i}^{′} )$$

is reasonable and returns

$$\vert τ - {τ}_{k}^{′} \vert ,$$

where

$${τ}_{i}^{′}$$

corresponds to the actual location locₖ. If the vehicle is in the right location, the difference must be negligible. The dummy locations can be randomly generated within a sphere the vehicle possibly can go from both the last and current payment locations in the time period. This is expressed by the following equation.

$$\vert τ - {τ}_{i}^{′} \vert < \vert τ - {τ}_{j}^{′} \vert if \vert {loc}_{k} - {loc}_{i} \vert < \vert {loc}_{k} - {loc}_{j} \vert \qquad Equation 16$$

A system of some example embodiments improves accuracy of a trend analysis as described hereafter. The original Kendall's t is about correlation between two sets of random variables as follows.

$$τ = \frac{2}{n ( n - 1 )} {\sum }_{i = 1}^{n - 1} {\sum }_{j = i + 1}^{n} sgn ( {d}_{j} - {d}_{j} ) sgn ( {t}_{j} - {t}_{i} ) \qquad Equation 17$$

For various example embodiments, the correlation is about the distance of each time period, where the time difference monotonically increases, i.e., sgn(tⱼ−tᵢ)=1 for tⱼ>tᵢ. Unfortunately, this provides limited accuracy (e.g., a degree of the distance, such as 100 km in 1 hour and 1 km in 1 hour, have the same degree of 1) even with a very high sampling rate.

A system of various example embodiments addresses this (and improves accuracy of the trend analysis) this by adjusting a time period according to the current speed.

$${K}_{r} = {\sum }_{i = 1}^{n - 1} sgn ( {d}_{j} - {d}_{i} ) {v}_{j} , \qquad Equation 18$$

where vⱼ is the average speed at the time tⱼ calculated from the relative distance (Haversine(locⱼ₋₁, locⱼ)).

Additionally, it can be efficient to calculate K_{τ} incrementally. A system of some example embodiments uses the algorithm described in Table 1 to determine (e.g., calculate) the K_{τ} as Kendall 1. The algorithm of Table 1 makes use of an augmented binary search tree having the size of the sub tree in each node (known as Order Statistic Tree). The algorithm can be performed in [symbol] (lg N).

TABLE 1

```
Input: loc: New location in the data stream, v: Velocity, K_{τ} :
Cumulative Kendall's kernel
Output: K_{τ}
Function Kendall(loc, v, Kₜ) :
m = Rank (root, loc, 0)
n = root.count
Kt += m * v
Kt −= (n − m) * v
InsertNode (root, loc)
Kt
Function Rank(root, key, ttl) :
if root = nil ∨ key = root.key then
  return ttl
end
if key < root.key then
  return Rank (root.left, key, ttl)
end
else
  return Rank (root.right, key, ttl + 1 + root.left.count)
end
```

A system of various example embodiments described herein uses an in-vehicle digital wallet that integrates blockchain technology to manage funds and securely store additional data, such as sensor data, subscription history, and charging history. With the use of a blockchain, a system of some example embodiments permits for: (1) enhanced security and immutability of records; (2) confidentiality and privacy preservation through advanced encryption techniques; and (3) decentralized and transparent ledger that provides a trustworthy platform for transactions.

According to some example embodiments, a system comprises a funds synchronization mechanism that enforces the synchronization of funds between a blockchain-based ledger (e.g., global blockchain-based ledger) and an in-vehicle digital wallet. In this way, a system of various example embodiments ensures that any negative balances are addressed promptly. The synchronization process can allow for real-time updating of account balances and can facilitate the immediate settlement of dues, thereby preventing the accumulation of debt and ensuring the smooth operation of the payment system. The combined operation of the in-vehicle digital wallet and the funds synchronization mechanism can result in a holistic in-machine wallet solution that significantly improves the safety, privacy, and user experience of an in-vehicle transaction system. As described herein, an in-vehicle transaction system of some example embodiments enables a vehicle to autonomously handle toll payments and other related transactions, which can provide for smart vehicular finance management.

A system of some example embodiments implements data Integrity with Zero Knowledge Proof (ZKP), which uses a concept of financial cryptography. For example, sensor data, activity histories, and other additional data can be hashed together with the commitments and proofs using Fiat-Shamir transform in the ZKP scheme. If this data is altered, the proof for the data will break and the funds linked to the proof will be lost.

For some example embodiments, the confidential ledger (e.g., used to store transactions) comprises an append-only key-value store and is globally accessible. ZKP techniques can be used not only to make the transaction confidential but also to ensure the validity of transactions, which is usually done by using digital signatures. This scheme does not offer anonymity, and transactions are traceable backward. For various example embodiment, this property can be used to “audit” transactions. All transaction data, such as the current balance, the payment amount and payees, can be managed confidentially using the confidential ledger.

The following Table 2 provides details regarding an example implementation of a confidential ledger using Zero Knowledge Proof of Balance (zkPoB) technique.

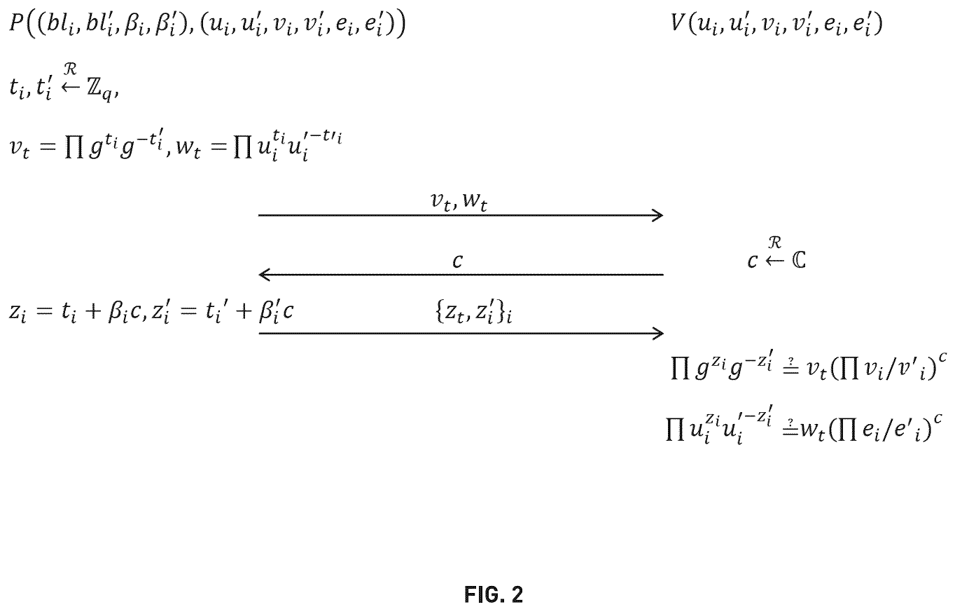

```
TABLE 2
In the balance chain, all some example embodiments need to know is the total balance before
and after a transaction is the same. If we denote blᵢ as the current balance of the entity i and
bl′ᵢ is the balance after a transaction, we have: $( \sum {bl}_{i} = \sum {bl}_{i}^{′} ) ∧ ( {bl}_{i}^{′} \geq 0 ) .$
For some example embodiments, each balance cannot be negative. To make it confidential,
some example embodiments use ElGamal (multiplicative) encryption, i.e.,
E(blᵢ) = (eᵢ, vᵢ) = (u^{β}^{ᵢ}, g^{bl}^{ᵢ}, g^{β}^{ᵢ}) with the public key u = g^{α}. For some example embodiments,
the relation of the total balance stays the same and can be verified on the encrypted data with
the following protocol for the relation:
  $R : = \{ \begin{matrix}( ( {bl}_{i} , {bl}_{i}^{′} , β {l}_{i} , β {l}_{i}^{′} ) , ( {u}_{i} , {u}_{i}^{′} , {v}_{i} , {v}_{i}^{′} , {e}_{i} , {e}_{i}^{′} ) ) : \\ {v}_{i} = {g}^{{β}_{i}} , {v}_{i}^{′} , = {g}^{{β}_{i}} {e}_{i} = {u}_{i}^{{β}_{i}} {g}^{{bl}_{i}} , {e}_{i}^{′} = {u}_{i}^{{′β}_{i}^{′}} {g}^{{bl}_{i}^{′}} , 0 \leq {bl}_{i}^{′} < {2}^{cl} , and {\sum }_{i} {bl}_{i} = {\sum }_{i} {bl}_{i}^{′}\end{matrix} \}$
With this relation, we have:
  $( {v}_{i} , {v}_{i}^{′} , {v}_{i} , {v}_{i}^{′} , {e}_{i} , {e}_{i}^{′} ) ∈ {L}_{ℛ} ⇐ ⇒ {v}_{i} = {g}^{{β}_{i}} , {v}_{i}^{′} = {g}^{{β}_{i}} , {\prod }_{i} {e}_{i} / {e}_{i}^{′} = {\prod }_{i} {u}_{i}^{{β}_{i}} {u}_{i}^{′ - {β}_{i}^{′}}$
if and only if $\sum {bl}_{i} = \sum {bl}_{i}^{′} .$ .
The Sigma protocol for [symbol]  is described and illustrated in FIG. 2.
The transaction is defined as:
$Tx := \{ {u}_{i} , {u}_{i}^{′} , {e}_{i} , {e}_{i}^{′} , {v}_{i} , {v}_{i}^{′} , {π}_{i} \} {π}_{i} , where = ( {v}_{t} , {w}_{t} , {z}_{i} , {z}_{i}^{′} ) .$
πᵢ is the proof converted from Sigma Protocol using Fiat-Shamir transform with
  $c = H ( {\{ {u}_{i} , {u}_{i}^{′} , {e}_{i} , {e}_{i}^{′} , {v}_{i} , {v}_{i}^{′} \}}_{i ,} {v}_{t} , {w}_{t} ) .$
```

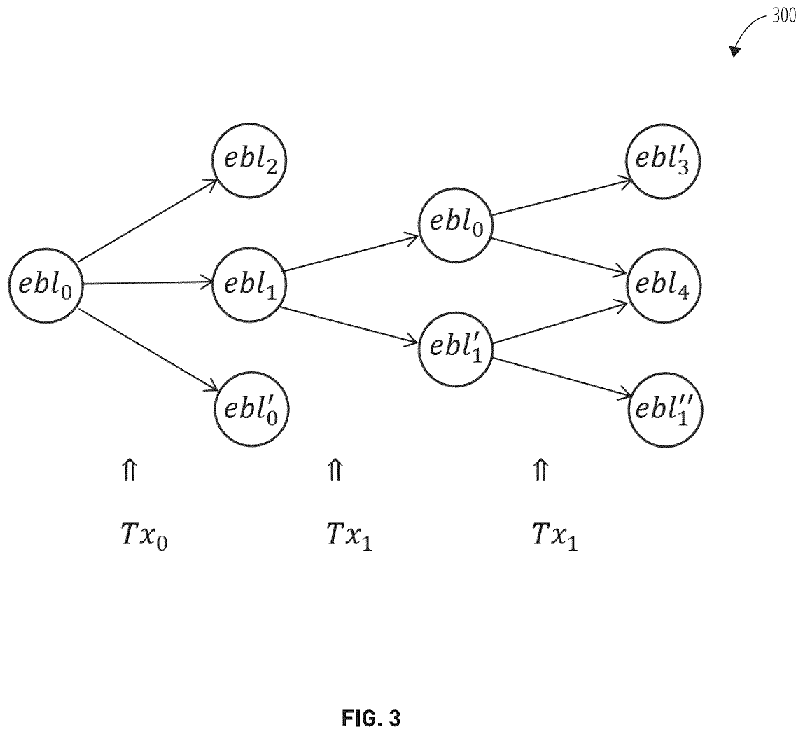

According to some example embodiments, the balance chain is implemented as described by the following. For some example embodiments, a transaction is written in the key-value store, with key=ci and value=tx. This key-value relation can form a DAG, such as illustrated by graph 300 of FIG. 3. The topical order can be guaranteed with PoB, and transactions can be written only when PoB (proof of burn) is verified. With PoB the key value store can be considered as a ledger. For some example embodiments, this ledger is append-only. According to various example embodiments, once a transaction is written to the ledger, the transaction will never be deleted or overwritten (e.g., write once property). Some example embodiments employ a distributed storage, which can make a system immune from equivocation.

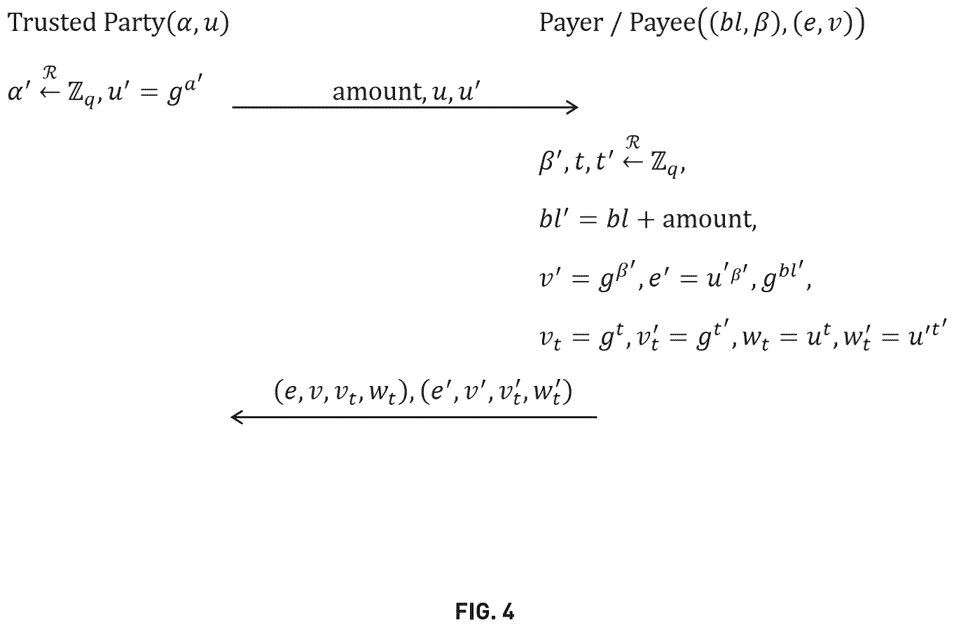

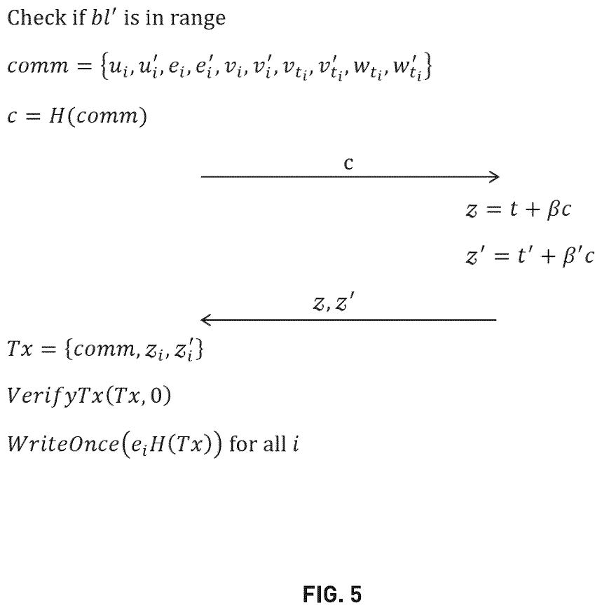

According to some example embodiments, the payment protocol is implemented as follows. A trusted party can be responsible for generating a fresh key pair (α, u) for every transaction. The trust party can also check whether a new balance is not negative when receiving an encrypted balance from each entity. At the end of the protocol, the trust party can verify the complete transaction constructed from the commitment and response using the Verify Tx algorithm (described in Table 3 below), then writes the result to the ledger. This is illustrated by FIG. 4 and FIG. 5.

```
TABLE 3
Input: Tx: The transaction, depth: How deeply the ledger is
verified
Output: true/false
Function VerifyTx (Tx, depth):
  if PoB.Verify(Tx) = false then
    return false
  end
  if dept = 0 then
    return true
  end
  foreach elm ∈ Tₓ do
    if validateOracle(elm.ebl) = false then
      return false
    end
    continue
  end
  if read(elm.ebl) ≠ H(Tx) ∨ VerifyTx(ReadArchive(elm.ebl), depth −
1) = false then
    return false
  end
end
return true
```

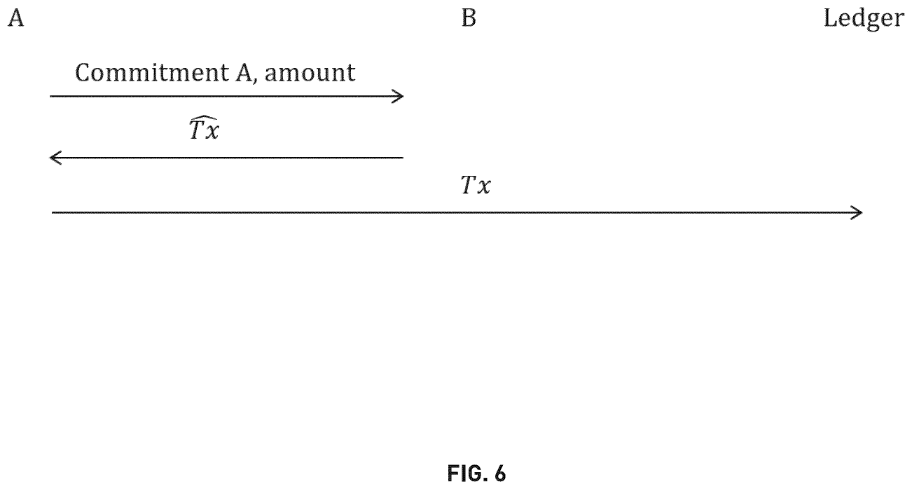

According to some example embodiments, peer-to-peer payment is implemented as follows. Either a payer or a payee can be an initiator in the peer-to-peer payment. As illustrated in FIG. 6, an entity A first calculates the commitment with an amount and sends it to a peer entity B. The receiving entity B can construct a Tx with its own commitment and response (z), and can send it back to entity A. Entity A can calculate the response z as well, complete the Tx, and then write it to the ledger.

According to some example embodiments, the payload for a transaction (e.g., electronic transaction) is implemented as described in Table 4.

TABLE 4

| type TxPayload struct { | |
|---|---|
| Version int | ‘json:“version”’ |
| Phase int | ‘json:“phase”’ |
| U [ ]byte | ‘json:“u”’ |
| Tx [ ]byte | ‘json:“tx”’ |
| } | |
| const ( | |
| VersionLite = 0 | |
| ) | |
| const ( | |
| PhaseInit = iota | |
| PhaseComplete | |
| ) | |
| type P2PPayload struct { | |
| Version int | ‘json:“version”’ |
| Id string | ‘json:“id”’ |
| amount int | ‘json:“amount”’ |
| Tx [ ]byte | ‘json:“tx”’ |
| Aad [ ]byte | ‘json:“aad”’ |

}

Various example embodiments described herein provide a technical solution for, or technical improvement with respect to, a number of example technical problems. For instance, some example embodiments provide a technical solution for unreliable connectivity for vehicle payments. Vehicles frequently encounter connectivity outages when passing through toll gates or entering express lanes. Various example embodiments provide a system that implements an in-vehicle digital wallet that can: record negative balances during connectivity outages when sufficient funds aren't available; store transaction data locally in tamper-proof storage using Oblivious PRF for master key generation; synchronize stored transaction data with the blockchain-based ledger once connectivity is restored; implement secure computation environments to provide isolated execution space during offline operations; or some combination thereof.

In another instance, some example embodiments provide a technical solution for sensor data integrity and validation. With respect to vehicle payment systems, sensor readings can be noisy, inaccurate, or potentially tampered with. Various example embodiments provide a system that implements: privacy-preserving sensor data authorization using cumulative correlation to compute relationships between location and multiple sensor inputs over time; statistical validation using coskewness to evaluate relationships among data points; trend analysis using Kendall's tau to determine measure of ordinal association between quantities; machine learning models specifically trained for environmental variables at each location; or some combination thereof.

As another example, some example embodiments provide a technical solution for payment security and privacy. Conventional vehicle payment systems struggle to balance transaction transparency with user privacy while maintaining security. Some example embodiments provide a system that implements: integration of Zero Knowledge Proof techniques with blockchain technology; hashing of sensor data, activity histories, and additional data with commitments and proofs using Fiat-Shamir transform; secure storage of cryptographic operations through dedicated hardware security chips; ability to verify vehicle histories while maintaining previous owner privacy; or some combination thereof.

Depending on the example embodiment, hashing of sensor data, activity histories, or other data with commitments and proofs (e.g., using Fiat-Shamir transform) can be useful for securing relevant information (e.g., from tampering/manipulation) for insurance (e.g., vehicle insurance) purposes, traffic violation purposes, or the like. According to various example embodiments, sensor data is hashed as follows: c=H(comm, sensor data), where H is a hash function, where comm is a commitment (a cryptographic technique where a prover can send encrypted data to a verifier, effectively “locking” a secret value without revealing its actual content, thus proving they possess the information without disclosing it directly), where c is the resulting hash, and where the sensor data can comprise raw sensor data. For various example embodiments, the comm comprises an encrypted balance (e.g., eᵢ as shown in FIG. 5). Thereafter, c can be encrypted with raw sensor data as follows: Proof=E(c, sensor data), where E is the encryption. Subsequently, the Proof can be stored in the in-vehicle digital wallet. According to various example embodiments, since comm includes the encrypted balance (e.g., eᵢ), if the raw sensor data is altered, the balance will no longer be verified with zkPoB, and the assets (balance) would be invalidated. Also, if the Proof itself is deleted, the balance would be gone altogether and no additional transactions can be performed using the in-vehicle digital wallet. As a result, a user (e.g., driver or vehicle owner) would be deterred or discouraged from altering or delete the raw sensor data.

The Proof generated can be used to provide proof of the sensor data in different instances. For example, the Proof can be provided to: a law enforcer in case of traffic violations; an insurance company to evaluate driving behaviors (e.g., which can be to change or determine a driver's insurance premiums); and a toll agent to prove if a vehicle passed a given toll gate. Depending on the example embodiment, sensor data (e.g., raw sensor data) can comprise, without limitation, speed meter reading of a vehicle, accelerometer reading of a vehicle (e.g., for detecting hard braking or harsh driving), snapshot from a vehicle camera, seat occupancy data, and location or GPS data, such as latitude, longitude, heading, or the like (e.g., for tolling). The sensor data can include timestamp information. Additionally, the sensor data can be encrypted in vehicle with a unique key (as mentioned above), thereby rendering it not visible to another (e.g., third party) unless the user (e.g., driver) consents to provide the evidence.

In another example, some example embodiments provide a technical solution for complex multi-sensor payment event detection. Various example embodiments provide a system that implements: machine learning models trained to recognize objects while reducing false positives; integration of multiple sensor types (e.g., cameras, GPS, seat sensors, gear position indicators); specialized detection algorithms for different payment scenarios (e.g., toll gates, parking, HOV lanes); real-time validation of sensor data through cumulative correlation analysis; or some combination thereof.

In another instance, various example embodiments provide a technical solution for vehicle history and activity verification. Some example embodiments provide a system that implements: a blockchain-based ledger to record all transactions and activities; tamper-proof storage of sensor data and object detection results; logging of repair and charging histories in the in-vehicle digital wallet; verifiable proofs of activities linked to electronic financial transactions; implementation of smart contract applications for vehicle-related transactions; or some combination thereof.

As used herein, an in-vehicle digital wallet comprises a component or mechanism that implements a secure, autonomous transaction (e.g., financial transaction) management system integrated within a vehicle that handles transactions (e.g., payments) for various vehicle-related expenses. An in-vehicle digital wallet of various example embodiments stores data relating to vehicle transactions (e.g., financial transactions that include an electronic payment for the vehicle) or other information relating to the vehicle (e.g., vehicle sensor data or history of vehicle activity).

Use of various example embodiments described herein improves how in-vehicle computing devices handle one or more electronic financial transactions and maintain records in autonomous, proactive, secure, and transparent manner. Various example embodiments described herein use digital wallet technology specifically designed for vehicular use, particularly in the context of different payment events, such as toll payments and related services.

Reference will now be made in detail to various example embodiments of the present disclosure, examples of which are illustrated in the appended drawings. Various example embodiments described herein will be understood more fully from the drawings. The present disclosure may, however, be embodied in many different forms and should not be construed as being limited to the examples set forth herein.

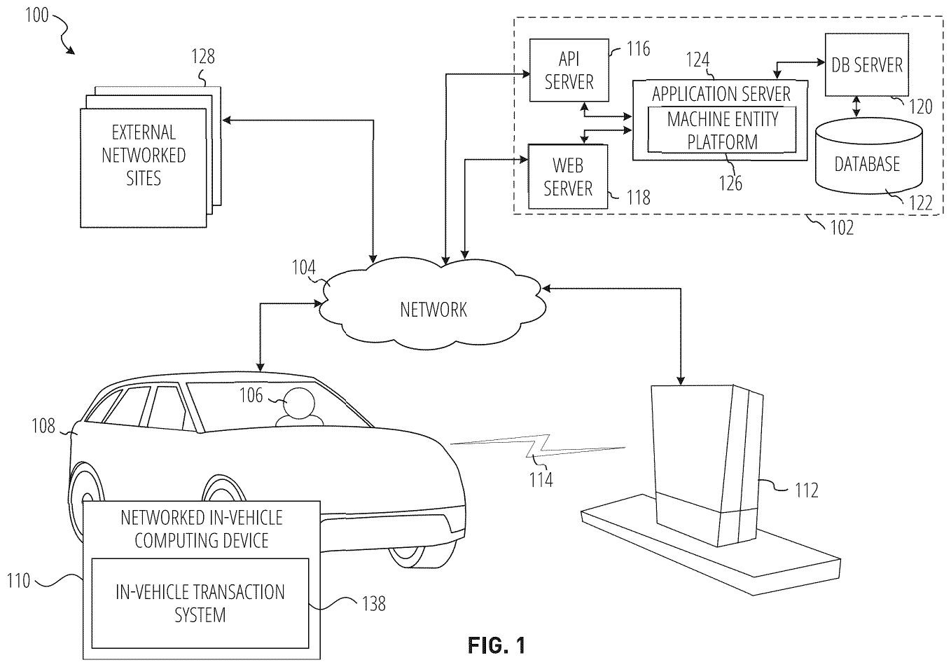

FIG. 1 is a diagrammatic representation of an example in-vehicle transaction system 138 in a networked environment 100 (e.g., client-server-based network architecture) in which the present disclosure may be deployed, in accordance with some example embodiments of the present disclosure. The in-vehicle transaction system 138 implements one or more features of various example embodiments described herein. For instance, with respect to the vehicle 108, the in-vehicle transaction system 138 can integrate one or more of machine learning, vehicle sensor data processing, and cryptographic security measures to facilitate proactive and automated transactions (e.g., financial transactions) directly from the vehicle 108.

With reference to FIG. 1, an example of a high-level client-server-based networked environment 100 that can implement various example embodiments described herein. A networked system 102 is shown in the example forms of a network-based management platform that can provide server-side processing via a network 104 (e.g., the Internet or wide area network [WAN]) to one or more client devices, such as a networked in-vehicle computing device 110, which is part of a vehicle 108. The networked in-vehicle computing device 110, and the in-vehicle transaction system 138 included therein, interact with a machine entity platform 126 hosted on an application server 124 to implement service tasks that are managed or performed on the networked in-vehicle computing device 110.

In some example embodiments, a user (e.g., driver 106) of the vehicle 108 interacts with the networked in-vehicle computing device 110, which then further interacts with the networked system 102 to perform interactions with one or more external networked sites 128 (e.g., vehicle maintenance, vehicle toll payment, streaming music payment). For example, the networked in-vehicle computing device 110 can interact with the external fuel pump to request authorization to receive gasoline or a device associated with a tollgate to pay for a toll. In some example embodiments, the networked in-vehicle computing device 110 interacts wirelessly 114 with the external fuel pump 112 (at a service station) or the device associated with a tollgate to initiate the authentication and authorization. In other example embodiments, the networked in-vehicle computing device 110 initiates the request directly to the machine entity platform 126, which then authenticates the networked in-vehicle computing device 110 and authorizes the transaction.

The networked in-vehicle computing device 110 can comprise a processor to execute instructions in an integrated memory, and a plurality of sensors that measure different parameters in connection with the vehicle 108. For example, a sensor can measure different operational parameters of the vehicle 108, such as an odometer that measure how far the vehicle 108 traveled, a fuel gauge measures the fuel level of the vehicle 108, a location sensor (e.g., GPS sensor) can measure the vehicle 108's current and past locations, and so on. The sensor data from the plurality of sensors is provided to the networked in-vehicle computing device 110 via a vehicle interface of the vehicle 108 (e.g., a telematics interface, OEM interface, OBD interface, API network interface).

In some example embodiments, the vehicle 108 and the networked in-vehicle computing device 110 communicate with the network 104 via a wired or wireless connection. For example, one or more portions of the network 104 comprises an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the public switched telephone network (PSTN), a cellular telephone network, a wireless network, a Wireless Fidelity (Wi-Fi®) network, a Worldwide Interoperability for Microwave Access (WiMax) network, another type of network, or any suitable combination thereof.

A user (e.g., the driver 106) can comprise a person interacting with the 110. The user can interact with the networked environment 100 via the networked in-vehicle computing device 110 or another means. For instance, the user can provide input (e.g., touch screen input or alphanumeric input) to the networked in-vehicle computing device 110 and the input is communicated to networked system 102 via the network 104. In this instance, the networked system 102, in response to receiving the input from the user, communicates information to the networked in-vehicle computing device 110 via the network 104 to be presented to the user. In this way, the user can interact with the networked system 102 using the networked in-vehicle computing device 110.

An Application Program Interface (API) server 116 and a web server 118 are coupled to, and provide programmatic and web interfaces respectively to, an application server 124. The application server 124 can host machine entity platform 126, which can comprise one or more modules or applications and each of which can be embodied as hardware, software, firmware, or any combination thereof. The application server 124, in turn, shown to be coupled to a database server 120 that facilitates access to one or more information storage repositories, such as database 122 (e.g., relational database system), which can store or maintain a blockchain distributed ledger. Further, while the networked environment 100 shown in FIG. 1 employs a client-server architecture, various example embodiments described herein are not limited to such an architecture, and can equally well find application in a distributed, or peer-to-peer, architecture system.

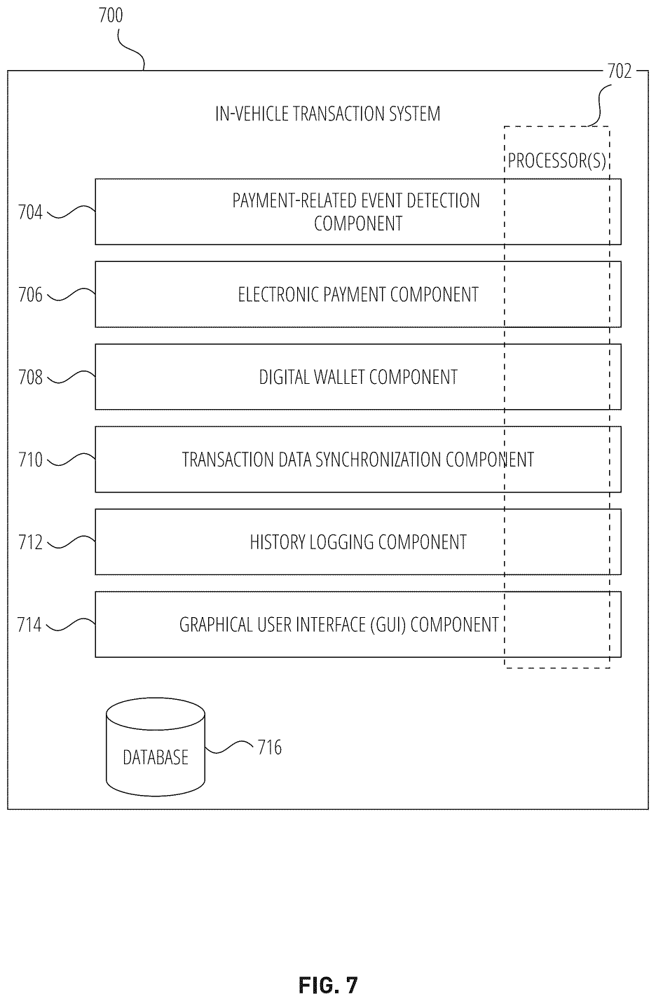

FIG. 7 is a block diagram illustrating an example implementation of an in-vehicle transaction system 700, according to various example embodiments of the present disclosure. For some example embodiments, the in-vehicle transaction system 700 represents an example of the in-vehicle transaction system 138 described with respect to FIG. 1. As shown, the in-vehicle transaction system 700 comprises a payment-related event detection component 704, an electronic payment component 706, a digital wallet component 708, a transaction data synchronization component 710, a history logging component 712, and a graphical user interface component 714. According to various example embodiments, one or more of the payment-related event detection component 704, the electronic payment component 706, the digital wallet component 708, the transaction data synchronization component 710, the history logging component 712, and the graphical user interface component 714 are implemented by one or more processors 702. Data generated by, or used by, one or more of the payment-related event detection component 704, the electronic payment component 706, the digital wallet component 708, the transaction data synchronization component 710, the history logging component 712, and the graphical user interface component 714 is stored on a database (or datastore) 716 of the in-vehicle transaction system 700.

The payment-related event detection component 704 is configured to implement or support detection of one or more payment-related events with respect to a vehicle (e.g., vehicle 108) that includes the in-vehicle transaction system 700. The electronic payment component 706 is configured to implement or support handling one or more electronic payments in connection with a detected payment-related event. The digital wallet component 708 is configured to implement or support an in-vehicle digital wallet for use by the in-vehicle transaction system 700 and its various components. The transaction data synchronization component 710 is configured to implement or support synchronization of data (e.g., transaction) stored in an in-vehicle digital wallet with a blockchain-based ledger, which can be maintained by or hosted on a system (e.g., networked system 102) external to the vehicle. As described herein, the in-vehicle transaction system 700 can be operatively coupled to a system over a network (e.g., network 104) that is maintaining/host services (e.g., blockchain-based ledged) used by the in-vehicle transaction system 700. The history logging component 712 is configured to implement or support logging of a history of the vehicle in the in-vehicle digital wallet of the vehicle. The graphical user interface component 714 is configured to enable a user (e.g., driver 106) at a device within a vehicle (e.g., vehicle 108) to access and use one or more features of the in-vehicle transaction system 700.

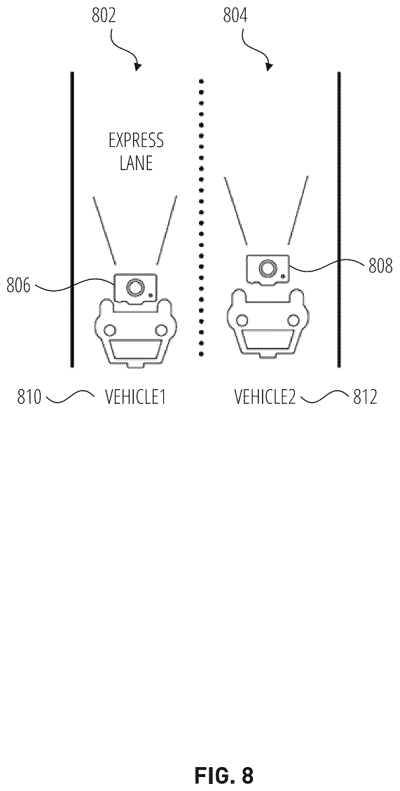

FIG. 8 is a schematic representation of an example roadway with two lanes: an express vehicle lane 802 that includes an “EXPRESS LANE” sign (e.g., of a roadway, such as a highway); and a non-express vehicle lane 804 (e.g., normal lane of the roadway). Examples of an express vehicle lane can include, without limitation, a toll road or other fee-based vehicle lane. Two vehicles (e.g., car or truck), VEHICLE1 (810) and VEHICLE2 (812), are shown traveling in parallel lanes. As shown, VEHICLE1 is positioned in the express vehicle lane 802 and comprises a first on-board sensor device 806 (e.g., on-board camera or radio frequency sensor) that the VEHICLE1 uses to monitor for (e.g., recognize) one or more road signs (e.g., lane designations), which can help VEHICLE1 designate between lanes. Accordingly, as VEHICLE1 passes through the express vehicle lane 802, the first on-board sensor device 806 can sense (e.g., recognize) the “EXPRESS LANE” sign. In contrast, VEHICLE2 is positioned in the non-express vehicle lane 804 and comprises a second on-board sensor device 808 (e.g., on-board camera or radio frequency sensor) that is not configured to monitor for (e.g., recognize) one or more road signs (e.g., lane designations).

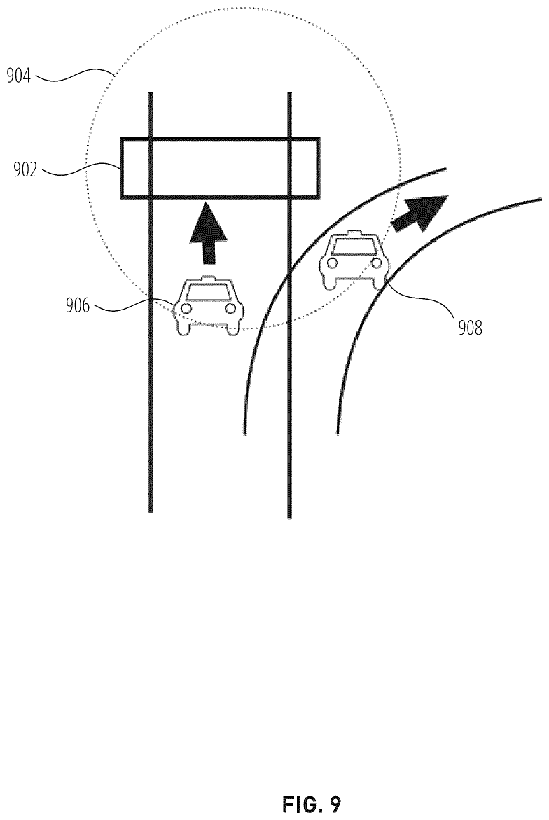

FIG. 9 presents a schematic representation of two vehicles, VEHICLE3 (906) and VEHICLE4 (908), approaching a structure 902 for a toll gate from different lanes. VEHICLE3 (906) on the left is approaching the toll gate structure 902 directly, while the VEHICLE4 (908) approaches adjacent to the toll gate structure 902. VEHICLE3 (906) comprises a detection mechanism (e.g., an on-board sensor device, such as a camera device) that enables VEHICLE3 (906) to detect (e.g., recognize) the toll gate structure 902 when the VEHICLE3 (906) is within a certain vicinity 904 of the toll gate structure 902. In comparison to VEHICLE3 (906), VEHICLE4 (908) on the right is depicted outside of the tollgate's detection zone, indicated by the absence of a dotted circle around it. VEHICLE4 (908) is shown taking an alternative path that bypasses the toll gate structure 902, with an arrow denoting its forward motion away from the toll gate structure 902. FIG. 9 illustrates how transaction systems of some example embodiments can discern and respond to infrastructure elements such as tollgates, which could be integral for automatic toll payment systems or for navigational assistance in vehicles.

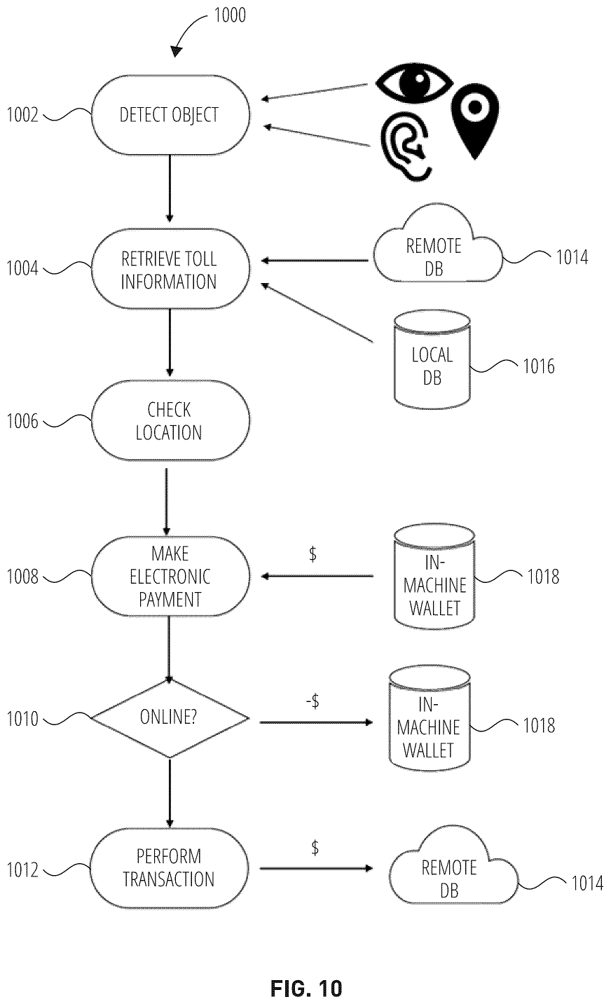

FIG. 10 outlines a flowchart describing an example method 1000 for automated payment when a system of a vehicle detects a tollgate or a road sign associated with a toll gate, in accordance with some example embodiments of the present disclosure. An in-vehicle system of some example embodiments starts at operation 1002 with “Detect Object,” where the vehicle's sensors identify the relevant object, such as a tollgate or a road sign associated with the toll gate. This detection process can involve visual recognition or GPS location data (as indicated by the icons). Following detection, at operation 1004, a system of some example embodiments “Retrieves Toll Information” from either a remote DB 1014 (e.g., database) or a local DB 1016. In this way, the system can have the capability to access toll data from cloud-based services or an onboard (e.g., in-vehicle) database.

Once the toll information is retrieved, at operation 1006, the system of some example embodiments “Checks Location” to confirm the vehicle's position relative to the tollgate, which can ensure accurate billing. Subsequently, at operation 1008, the system of various example embodiments causes an electronic payment to be made (“Makes a Payment”), where the system interfaces with an in-machine digital wallet 1018 (“In-machine Wallet”) to perform an electronic payment transaction. The in-machine digital wallet can provide an integrated payment system within the vehicle that can directly handle transactions.

At decision point 1010, the system of various example embodiments determines whether the system is online (e.g., connected over a network) with respect to a remote system (e.g., one maintaining or hosting a blockchain-based ledger). The system can use this determination to determine the nature of the transaction to be performed/processed. If the system is online (e.g., online connectivity to the remote DB 1014 is available), the system of some example embodiments processes the electronic payment transaction immediately at operation 1012. This is represented by “$” which represents an electronic payment being transferred to remote DB 1014. If the system is not online (e.g., online connectivity to the remote DB 1014 is not available), the system of various example embodiments causes funds to be deducted from the in-machine digital wallet 1018. This process is considered a payment during offline payment mode and represented by “−$” to the in-machine digital wallet 1018 (which represents the recording of the deduction of funds).

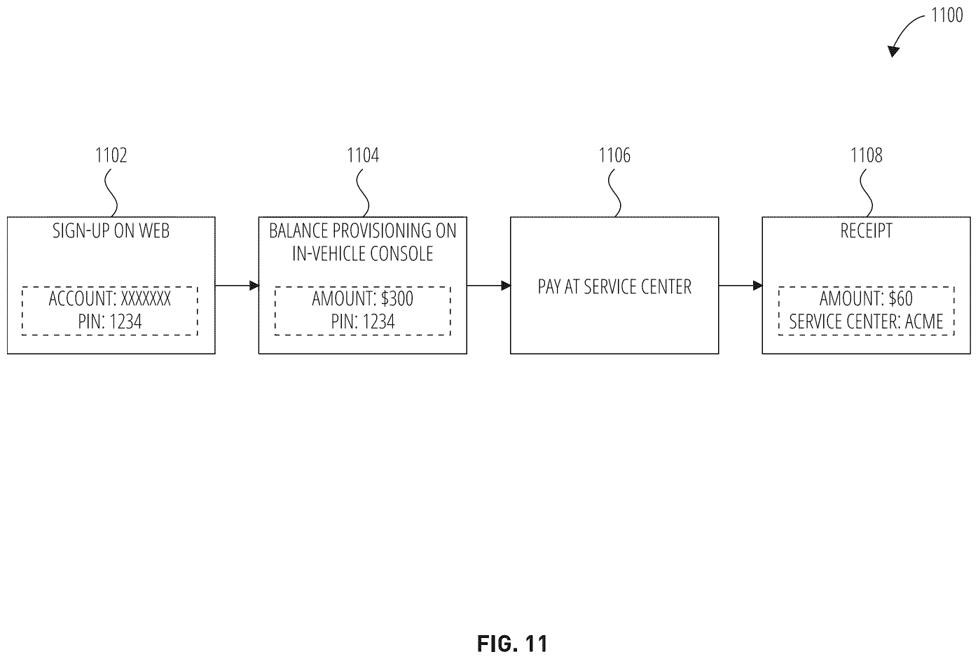

FIG. 11 is a flowchart 1100 illustrating an example of how a prepaid scenario can be processed by a system, in accordance with some example embodiments of the present disclosure. As shown, at operation 1102, a user signs up an account via a website, and at operation 1104, the user provisions a balance (e.g., of $300) in connection with the account using an in-vehicle console of a vehicle. When the vehicle is at a service center (or other location associated with a payment-related event as described herein), at operation 1106, an electronic payment is processed in connection with the vehicle. Eventually, at operation 1108, the user (or owner of the vehicle) receives a receipt associated with the processed payment.

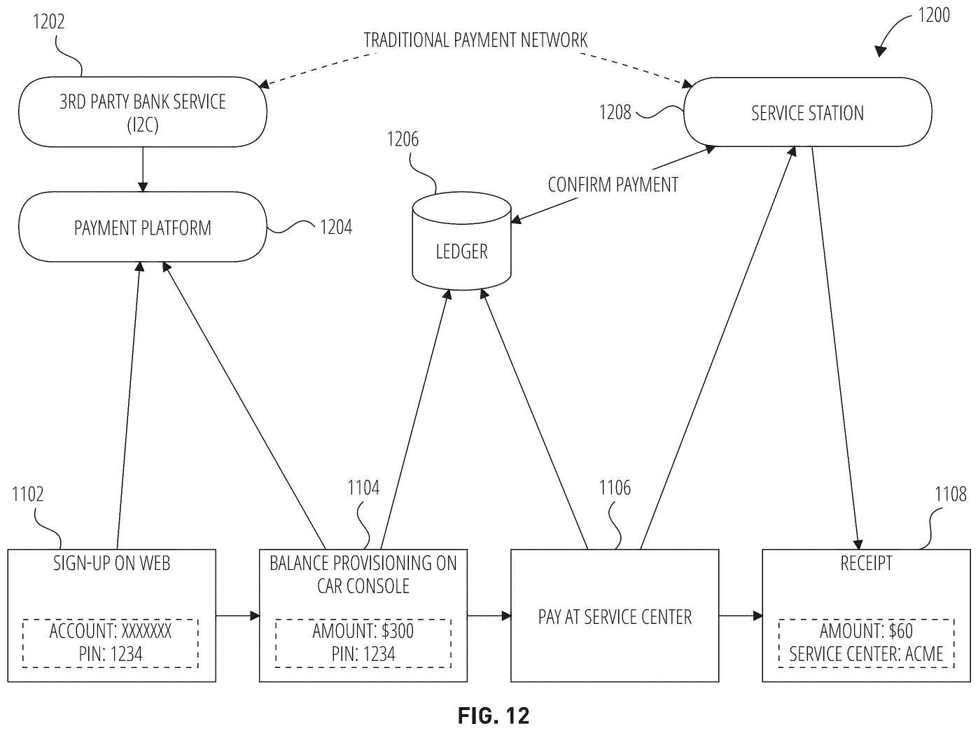

FIG. 12 is a flowchart 1200 illustrating an example of how a transaction can be processed by a system, in accordance with some example embodiments of the present disclosure. As shown, operations 1102, 1104, 1106, 1108 of FIG. 11 involve use of (e.g., interact with) a 3rd party bank service (I2C) 1202, a payment platform 1204, a blockchain-based ledger 1206, and a service station 1208. The ledger (1206) of the example transaction can keep every transaction encrypted while allowing anyone access to the ledger without permission. The ledger (1206) can ensure that anyone can verify transactions without central authority. The ledger (1206) can be reliable, can have high availability, and can implement a key-value store. The ledger (1206) can store tamper-resistant records of all transactions made by vehicles. The ledger (1206) can accommodate extra verifiable data, such as location, VIN, meter reading, and the like. Additionally, the ledger (1206) can also provide auditable proofs with an L1 blockchain.

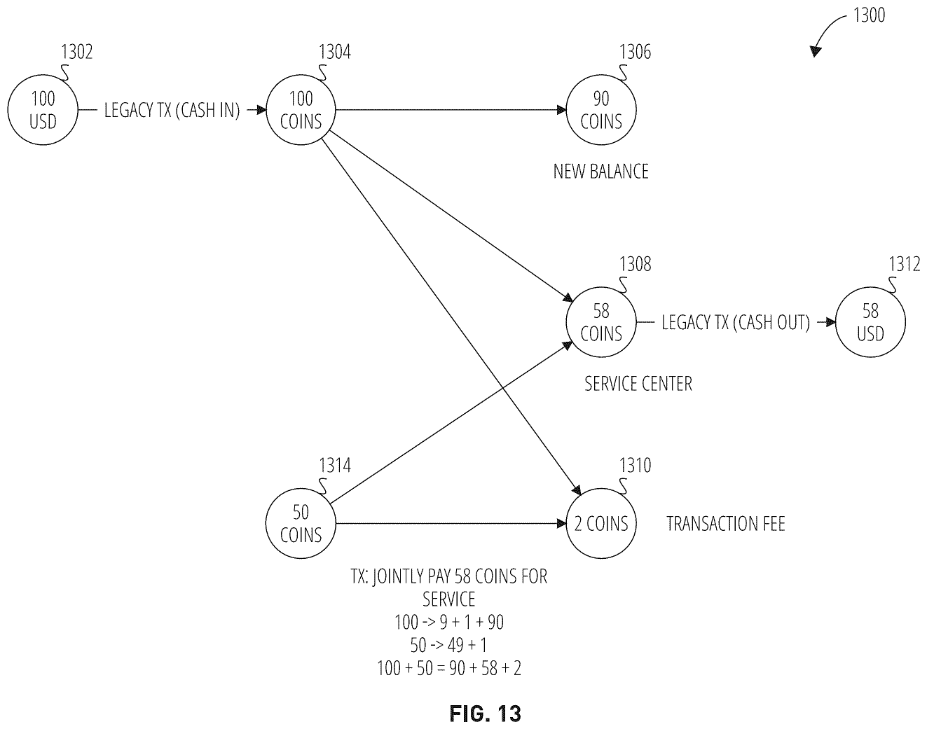

FIG. 13 is a graph 1300 illustrating an example of how a balance-based ledger can be used by a system, in accordance with some example embodiments of the present disclosure. In particular, the graph 1300 represents a key-value store, where the key-value store forms a directed acyclic graph (DAG) with vertices (key)=balances, and edges (value)=transactions. Topological order can be guaranteed by ensuring that a new balance is created from existing balances. Balances before and after a transmission (TX) would remain the same, where Σ current balances=Σ new balances. As shown, node 1302 represents 100 U.S. Dollars (USD), node 1304 represents 100 coins, node 1306 represents 90 coins, node 1308 represents 58 coins, node 1310 represents 2 coins, node 1312 represents 58 coins, and node 1314 represents 50 coins.

While a blockchain-based ledger (e.g., ledger 1206) of various example embodiments can be permissioned and private, all transactions can be accessible while ZKP techniques are used to hide a user's identity, balance, and transactions. The ledger can introduce “write-once” property with TOFU (Trust on First Use) policy, and only ephemeral keys can be stored (e.g., no long-term keys are stored).

Within the ledger, the balance can be encrypted. For example, an ElGamal (multiplicative) encryption of g\hat{ }b1 (aka Pedersen commitment) can be used. The calculation on encrypted data can comprise E(b11)*E(b12)=E (b11+b12), where E(b1) will be the unique key in the confidential ledger. Proof of Balance (PoB) can be used to prove the ownership of the balance. The transaction (Tx) can equal {E(b1), E(b1′), PoB}, where the current and new balances with the proof of balance are stored at E(b1).

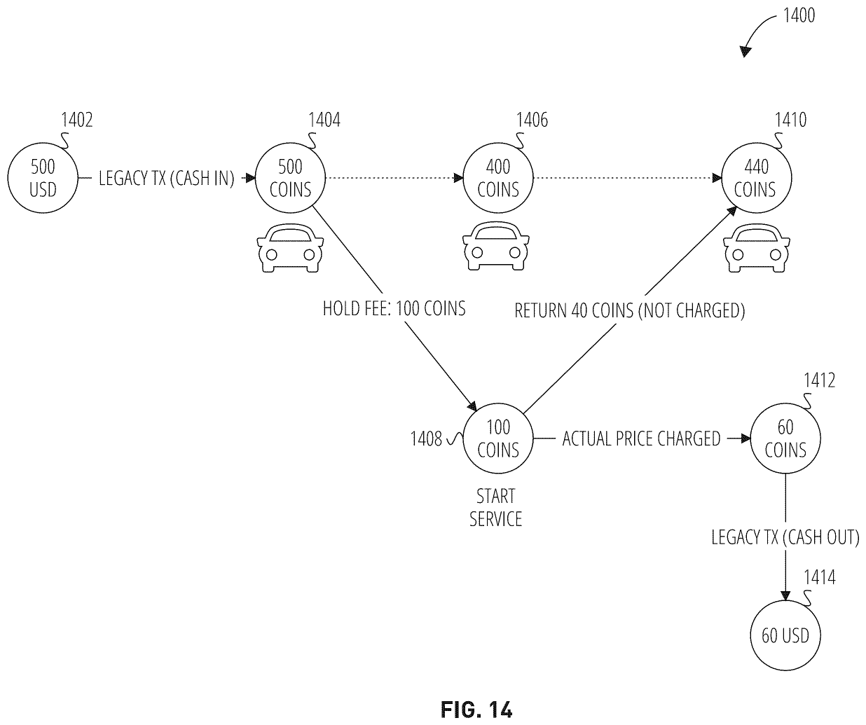

FIG. 14 is a graph 1400 illustrating an example of how an electronic transaction can be processed by a system, in accordance with some example embodiments of the present disclosure. The graph 1400 is similar to the graph 1300 of FIG. 13 (where the graph 1400 represents a key-value store that forms a DAG with vertices (key)=balances, and edges (value)=transactions). As shown, node 1402 represents 500 U.S. Dollars (USD), node 1404 represents 500 coins, node 1406 represents 400 coins, node 1408 represents 100 coins, node 1410 represents 440 coins, node 1412 represents 60 coins, and node 1414 represents 60 USD. In FIG. 14, the fueling of a vehicle starts only when the hold fee is confirmed with a blockchain-based ledger (e.g., ledger 1206). Using the ledger, a user can dispute an electronic transaction by showing that the complete electronic transaction is not recorded in the ledger.

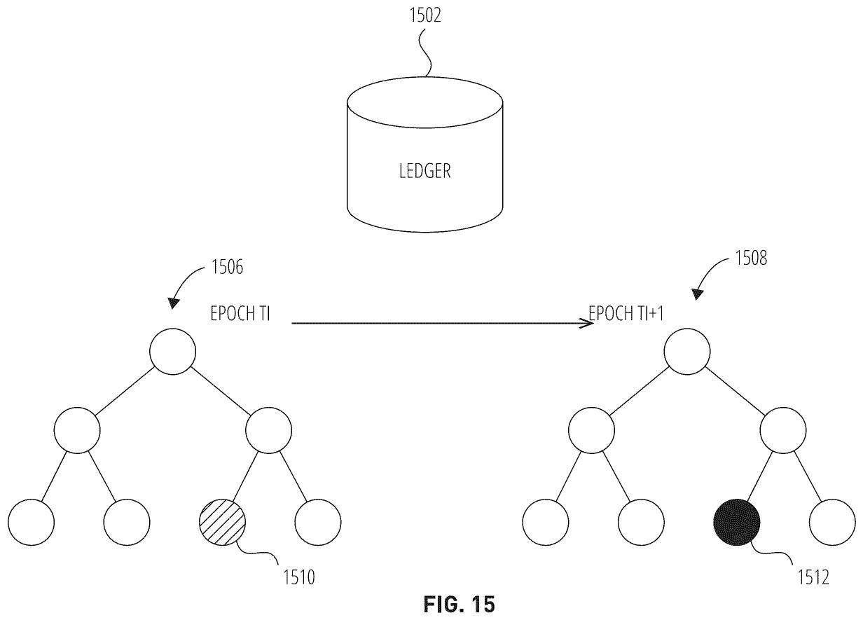

FIG. 15 is a diagram illustrating an example of how to implement auditable, tamper-evidence proofs that can be used by a system, in accordance with some example embodiments of the present disclosure. As shown, a blockchain-based ledger 1502 can comprise a L1 blockchain-based ledger, where a current hash can be set to H (Merkle root+Epoch+Prev hash). The current hash H can be placed in the L1 chain periodically (e.g., every 24 hours). Graph 1506 can represent data within the ledger 1502 at Epoch Ti and graph 1508 can represent data within the ledger 1502 at Epoch Ti+1. Node 1510 in graph 1506 can represent a non-inclusive proof at Ti, and node 1512 in graph 1508 can represent an inclusive proof at Ti+1. According to various example embodiments, a pair of Merkle proofs are kept, and each E(b1) is put into a leaf node of a graph. Some example embodiments use a sparse Merkle tree.

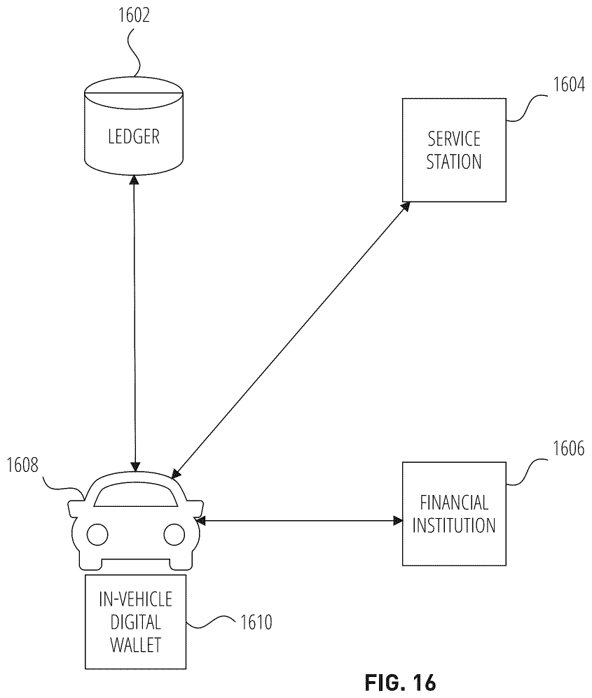

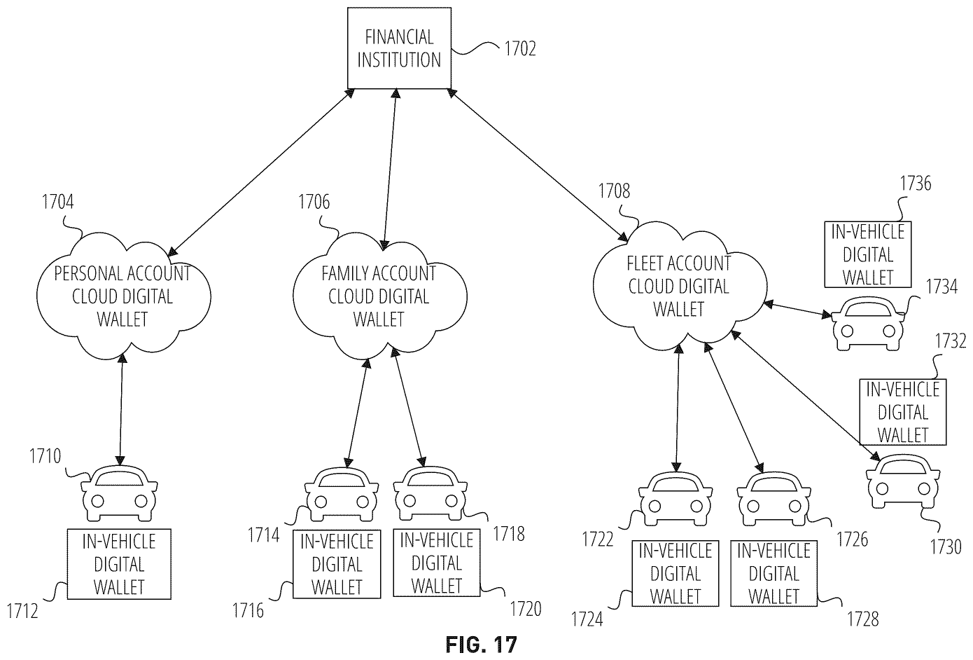

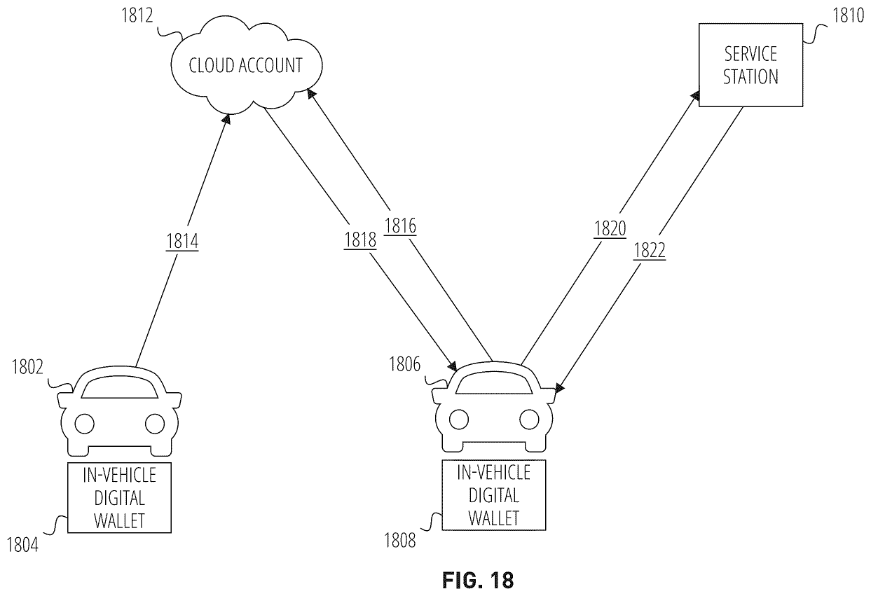

FIG. 16 through FIG. 18 illustrate examples of how an in-vehicle digital wallet can be used by a system, in accordance with some example embodiments of the present disclosure. As shown, each vehicle (e.g., 1608, 1710, 1714, 1718, 1722, 1726, 1730, 1734, 1802, 1806) comprises in-vehicle digital wallet (e.g., 1610, 1712, 1716, 1720, 1724, 1728, 1732, 1736, 1804, 1808), which can be linked to a user (e.g., personal account cloud digital wallet 1704), a family (e.g., family account cloud digital wallet 1706), a company, a fleet (e.g., fleet account cloud digital wallet 1708), or another account. Each account can be linked to a financial institution (e.g., 1606, 1702). According to some example embodiments, an in-vehicle digital wallet helps build a decentralized payment system. For some example embodiments, the in-vehicle digital wallet is used to perform an electronic transactions (Tx) directly with a payment/merchant system (e.g., service station 1604, service station 1810). FIG. 16 specifically illustrates an example of a direct in-car payment using an in-vehicle digital wallet 1610 with respect to vehicle 1608, FIG. 17 illustrates a cash-in transaction with in-vehicle digital wallets associated with different vehicles (e.g., 1710, 1714, 1718, 1722, 1726, 1730, 1734), and FIG. 18 illustrates an example of electronic transactions for a shared account.

In FIG. 16, vehicle 1608 makes a transaction with a payment/merchant (e.g., service station 1604) to move funds. All electronic transactions are stored in blockchain-based ledger 1602. During operation, monetary value moves in and out of the in-vehicle digital wallet 1610 directly. With various example embodiments, there is no central entity, there is no single point of failure, privacy data stays within a vehicle, and the system is scalable.

In FIG. 17, use of the accounts (e.g., 1704, 1706, 1708) can enable a system of some example embodiments to implement a prepay model. Generally, an electronic transaction can comprise monetary value moving from an account (e.g., 1704, 1706, 1708) to a vehicle (e.g., 1710, 1714, 1718, 1722, 1726, 1730, 1734), and from the vehicle to a merchant (e.g., service station).

In FIG. 18, assume that cloud account 1812 is storing an initial deposit (e.g., $1000). Vehicle 1802 can initiate (1814) an electronic transaction (e.g., up to $1000) from vehicle 1802 to the cloud account 1812. At the same time, vehicle 1806 can initiate (1816) an electronic transaction with a hold fee (e.g., $100). The hold fee can be applied to the 1812, thereby leaving the cloud account 1812 with a balance minus the hold fee. If there is sufficient funds in the cloud account 1812 to cover the hold fee, the cloud account 1812 authorizes (1818) vehicle 1806 for the electronic transaction. In turn, vehicle 1806 can authorize (1820) an electronic transaction (e.g., of up to $100) with a merchant (e.g., service station 1810) and, upon the electronic transaction being authorized, 1806 can receive (1822) from the merchant a completed electronic transaction with an adjustment value (e.g., $60). Eventually, vehicle 1806 can finalize the adjustment by applying it to the balance stored in the cloud account 1812 (e.g., $940).

Although the described flowcharts can show operations as a sequential process, many of the operations can be performed in parallel or concurrently. In addition, the order of the operations can be re-arranged. A process is terminated when its operations are completed. A process can correspond to a method, a procedure, an algorithm, etc. The operations of methods may be performed in whole or in part, can be performed in conjunction with some or all of the operations in other methods, and can be performed by any number of different systems, such as the systems described herein, or any portion thereof, such as a processor included in any of the systems.

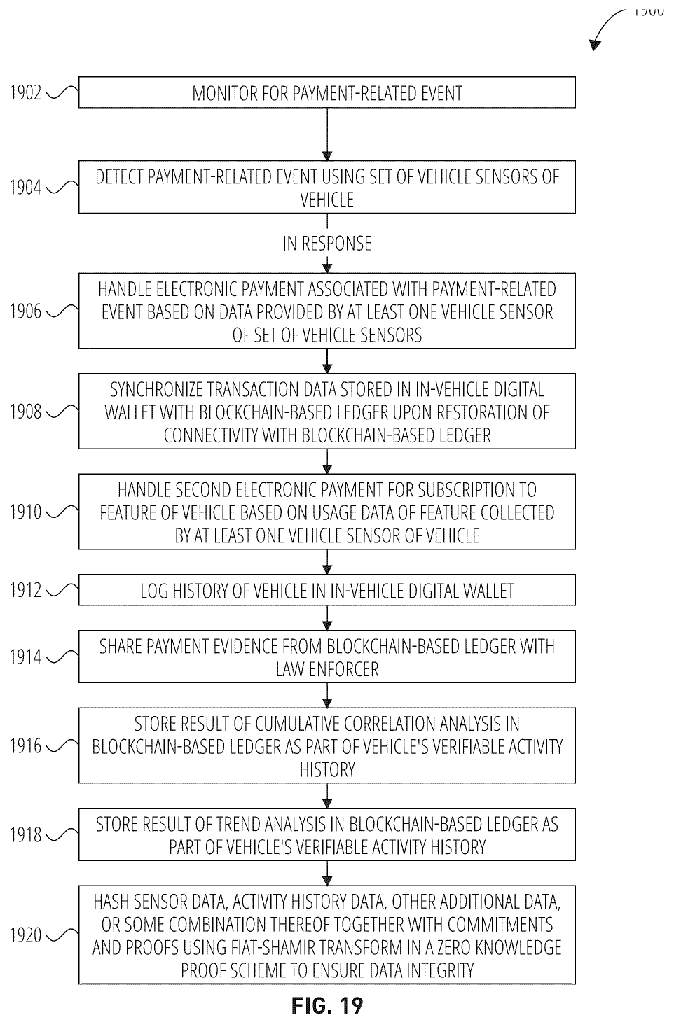

FIG. 19 is a flowchart illustrating example method 1900 for facilitating automated transactions from a vehicle based on a set of vehicle sensors (e.g., inside the vehicle or affixed to the exterior of the vehicle), in accordance with some example embodiments of the present disclosure. For explanatory purposes, method 1900 is primarily described herein with reference to the in-vehicle transaction system 138 of FIG. 1. However, one or more operations of method 1900 can be performed by one or more other components, or by other suitable devices. Further, for explanatory purposes, the operations of any of method 1900 are described herein as occurring in serial, or linearly. However, multiple operations of any of method 1900 can occur in parallel or concurrently. In addition, the operations of method 1900 need not be performed in the order shown or one or more operations of any of method 1900 need not be performed or can be replaced by other operations. Method 1900 can be terminated when its operations are completed. In addition, method 1900 can correspond to a process, a procedure, an algorithm, etc.

At operation 1902, a processor (e.g., of the in-vehicle transaction system 138) monitors for a payment-related event. Example payment-related events can include, without limitation, events associated with a vehicle toll gate (e.g., vehicle 108 passing through a toll gate), a vehicle parking (e.g., vehicle 108 parking in a for-pay parking space), a vehicle subscription for one or more enhanced features (e.g., within the vehicle 108), and a vehicle traffic violation (e.g., occurs in connections with a driver operating vehicle 108).

In operation 1904, the processor detects the payment-related event using a set of vehicle sensors of a vehicle (e.g., vehicle 108). For some example embodiments, the set of vehicle sensors comprises at least one of a camera or a geospatial positioning system (GPS) unit. Additionally, for some example embodiments, the detection of the payment-related event comprises detecting the payment-related event using a machine learning model that is trained to recognize one or more objects associated with at least the payment-related event while reducing false positives. According to some example embodiments, operation 1904 comprises detecting the payment-related event in association with a geographical location of the vehicle based on the set of vehicle sensors, where a camera of the set of vehicle sensors comprises generates a digital image, where the GPS unit provides the geographical location, and where the detecting of the payment-related event comprises using a machine learning model trained to recognize in the digital image one or more objects associated with the payment-related event. Additionally, for some example embodiments, operation 1904 comprises recording at least one of the data or an object detection result associated with the payment-related event in an in-vehicle digital wallet.

Where the payment-related event comprises the vehicle traveling in a High Occupancy Vehicle (HOV) lane while the vehicle lacks eligibility, the detection of the payment-related event can comprise the processor using the camera of the set of vehicle sensors to detect that the vehicle is traveling the HOV lane. Using a seat occupancy sensor of the vehicle, the processor can determine a number of passengers in the vehicle. The processor can then verify eligibility of the vehicle in the HOV lane based on the number of passengers. In response to the vehicle failing eligibility in the HOV lane, the processor can detect the payment-related event (of the vehicle traveling in a HOV lane while the vehicle lacks eligibility).

Where the payment-related event comprises the vehicle parking in a paid parking space, the detection of the payment-related event can comprise the processor using at least one of the GPS and the camera to detect that the vehicle is occupying an exact location of the paid parking space. In such instances, the processor can handle the electronic payment associated with the payment-related event (at operation 1906) by using at least one of a gear position indicator of the vehicle or a speedometer of the vehicle to determine a parking duration of the vehicle in the paid parking space, and the processor can determine a fee calculation for the electronic payment based on the parking duration.

Where the payment-related event comprises the vehicle traveling through a toll gate, the detection of the payment-related event can comprise the processor using at least one of the GPS and the camera to detect the toll gate, where the processor can use the machine learning model to detect the toll gate. For various example embodiments, the machine learning model is trained to detect one or more unique characteristics of one or more toll gates. In such instances, the processor can handle the electronic payment associated with the payment-related event (at operation 1906) by automatically initiating the electronic payment from the in-vehicle digital wallet in response to detection of the toll gate.

Where the payment-related event comprises a vehicle infraction, the detection of the payment-related event can comprise the processor detecting the vehicle infraction based on sensor data collected from the set of vehicle sensors. In such instances, the processor can handle the electronic payment associated with the payment-related event (at operation 1906) by processing a fine associated with the vehicle infraction.

In response to detecting the payment-related event, at operation 1906, the processor handles an electronic payment associated with the payment-related event based on data provided by at least one vehicle sensor of the set of vehicle sensors. In particular, for some example embodiments, 1906 comprises handling the electronic payment associated with the payment-related event based on at least one object recognized in a digital image generated by a camera of the set of vehicle sensors. For various example embodiments, the electronic payment is handled by using an in-vehicle digital wallet to make the electronic payment and by using a blockchain-based ledger to record the electronic payment. For some example embodiments, the in-vehicle digital wallet is implemented using a tamper-proof storage system configured to ensure security and integrity of stored data using at least one of: an Oblivious Pseudo-Random Function (PRF) to generate a master key for encrypting stored data on the tamper-proof storage system; a secure computation environment that provides an isolated execution space on the tamper proof storage system; or a secure element hardware chip of the tamper-proof storage system.

During operation 1908, the processor synchronizes transaction data stored in the in-vehicle digital wallet with the blockchain-based ledger upon restoration of connectivity with the blockchain-based ledger. For various example embodiments, during loss of connectivity, the processor is configured to record (or cause the recording of) negative balances in the in-vehicle digital wallet in response to sufficient funds not being available in the in-vehicle digital wallet for performing the electronic payment.

At operation 1910, the processor handles a second electronic payment for a subscription to a feature of the vehicle (e.g., 108) based on usage data of the feature collected by at least one vehicle sensor of the vehicle. Examples of features include, without limitation, fast charging for a vehicle and seat heating within a vehicle.

The method 1900 continues to operation 1912, where the processor logs history of the vehicle in the in-vehicle digital wallet. For example, the history can comprise information regarding at least one of repair or charging of the vehicle. Logging such activities can aid in transparency for potential future owner of the vehicle.

At operation 1914, the processor shares payment evidence from the blockchain-based ledger with a law enforcer. Examples of the law enforcer can include, without limitation, a police officer, a traffic officer, a federal officer (e.g., FBI officer), or the like.

During operation 1916, the processor stores a result of cumulative correlation analysis in the blockchain-based ledger as part of the vehicle's verifiable activity history. For various example embodiments, the cumulative correlation analysis computes relationships between location data and multiple sensor data inputs over time. As described herein, the cumulative correlation analysis can provide real-time validation (e.g., privacy-preserving authorization) of sensor data read (e.g., collected) by the processor to validate the consistency of sensor data and detect anomalies or discrepancies that indicate tampering or failure of a vehicle sensor. In this way, the cumulative correlation analysis can facilitate the detection and prevention of fraudulent activities.

For operation 1918, the processor stores a result of trend analysis in the blockchain-based ledger as part of the vehicle's verifiable activity history. For some example embodiments, the processor performs a trend analysis, where the trend analysis uses one or more statistical models to validate the consistency of sensor data and detect anomalies or discrepancies that indicate tampering or failure of a vehicle sensor. In this way, the trend analysis can facilitate the detection and prevention of fraudulent activities. The one or more statistical models used can vary between different example embodiments. For instance, the statistical model can comprise a statistical model for cumulative correlation of location and sensor data inputs from multiple vehicle sensors to detect fraudulent activity. As another example, the statistical model can comprise a statistical model for trend analysis of distance traveled using a measure of the ordinal association between two measured quantities to validate consistency of sensor data, where the validation can be used to detect the anomaly or discrepancy that indicates tampering or failure of the vehicle sensor

At operation 1920, the processor hashes sensor data, activity history data, other additional data, or some combination thereof together with commitments and proofs using Fiat-Shamir transform in a zero-knowledge proof scheme to ensure data integrity.

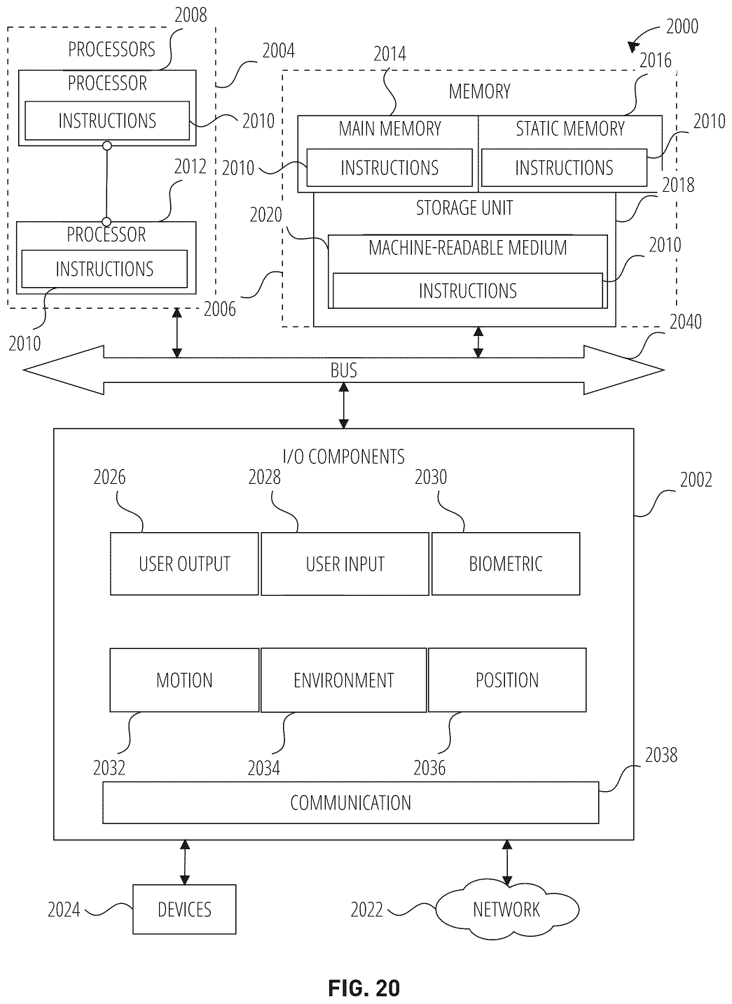

In some examples, components in the networked in-vehicle computing device 110, which includes the in-vehicle transaction system 138, can be a machine 2000 as shown in FIG. 20. FIG. 20 is a diagrammatic representation of the machine 2000 within which instructions 2010 (e.g., software, a program, an application, an applet, an application, or other executable code) for causing the machine 2000 to perform any one or more of the methodologies discussed herein may be executed. For example, the instructions 2010 may cause the machine 2000 to execute any one or more of the methods described herein. The instructions 2010 transform the general, non-programmed machine 2000 into a particular machine 2000 programmed to carry out the described and illustrated functions in the manner described. The machine 2000 may operate as a standalone device or may be coupled (e.g., networked) to other machines. In a networked deployment, the machine 2000 may operate in the capacity of a server machine or a client machine in a server-client network environment, or as a peer machine in a peer-to-peer (or distributed) network environment. The machine 2000 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 2010, sequentially or otherwise, that specify actions to be taken by the machine 2000. Further, while only a single machine 2000 is illustrated, the term “machine” shall also be taken to include a collection of machines that individually or jointly execute the instructions 2010 to perform any one or more of the methodologies discussed herein. The machine 2000, for example, may comprise the in-vehicle transaction system 138 or any one of a number of server devices forming part of the networked system 102. In some examples, the machine 2000 may also comprise both client and server systems, with certain operations of a particular method or algorithm being performed on the server-side and with certain operations of the particular method or algorithm being performed on the client-side.

The machine 2000 may include processors 2004, memory 2006, and input/output I/O components 2002, which may be configured to communicate with each other via a bus 2040. In an example, the processors 2004 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 2008 and a processor 2012 that execute the instructions 2010. The term “processor” is intended to include multi-core processors that may comprise two or more independent processors (sometimes referred to as “cores”) that may execute instructions contemporaneously. Although FIG. 20 shows multiple processors 2004, the machine 2000 may include a single processor with a single-core, a single processor with multiple cores (e.g., a multi-core processor), multiple processors with a single core, multiple processors with multiples cores, or any combination thereof.

The memory 2006 includes a main memory 2014, a static memory 2016, and a storage unit 2018, both accessible to the processors 2004 via the bus 2040. The main memory 2014, the static memory 2016, and storage unit 2018 store the instructions 2010 embodying any one or more of the methodologies or functions described herein. The instructions 2010 may also reside, completely or partially, within the main memory 2014, within the static memory 2016, within machine-readable medium 2020 within the storage unit 2018, within at least one of the processors 2004 (e.g., within the processor's cache memory), or any suitable combination thereof, during execution thereof by the machine 2000.

The I/O components 2002 may include a wide variety of components to receive input, provide output, produce output, transmit information, exchange information, capture measurements, and so on. The specific I/O components 2002 that are included in a particular machine will depend on the type of machine. For example, portable machines such as mobile phones may include a touch input device or other such input mechanisms, while a headless server machine will likely not include such a touch input device. It will be appreciated that the I/O components 2002 may include many other components that are not shown in FIG. 20. In various examples, the I/O components 2002 may include user output components 2026 and user input components 2028. The user output components 2026 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 2028 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 2002 may include biometric components 2030, motion components 2032, environmental components 2034, or position components 2036, among a wide array of other components. For example, the biometric components 2030 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 2032 include acceleration sensor components (e.g., accelerometer), gravitation sensor components, rotation sensor components (e.g., gyroscope).

The environmental components 2034 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

The position components 2036 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 2002 further include communication components 2038 operable to couple the machine 2000 to a network 2022 or devices 2024 via respective coupling or connections. For example, the communication components 2038 may include a network interface component or another suitable device to interface with the network 2022. In further examples, the communication components 2038 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 2024 may be another machine or any of a wide variety of peripheral devices (e.g., a peripheral device coupled via a USB).

Moreover, the communication components 2038 may detect identifiers or include components operable to detect identifiers. For example, the communication components 2038 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 2038, such as location via Internet Protocol (IP) geolocation, location via Wi-Fi® signal triangulation, location via detecting an NFC beacon signal that may indicate a particular location, and so forth.

The various memories (e.g., main memory 2014, static memory 2016, and memory of the processors 2004) and storage unit 2018 may store one or more sets of instructions and data structures (e.g., software) embodying or used by any one or more of the methodologies or functions described herein. These instructions (e.g., the instructions 2010), when executed by processors 2004, cause various operations to implement the disclosed examples.

The instructions 2010 may be transmitted or received over the network 2022, using a transmission medium, via a network interface device (e.g., a network interface component included in the communication components 2038) and using any one of several well-known transfer protocols (e.g., hypertext transfer protocol (HTTP)). Similarly, the instructions 2010 may be transmitted or received using a transmission medium via a coupling (e.g., a peer-to-peer coupling) to the devices 2024.

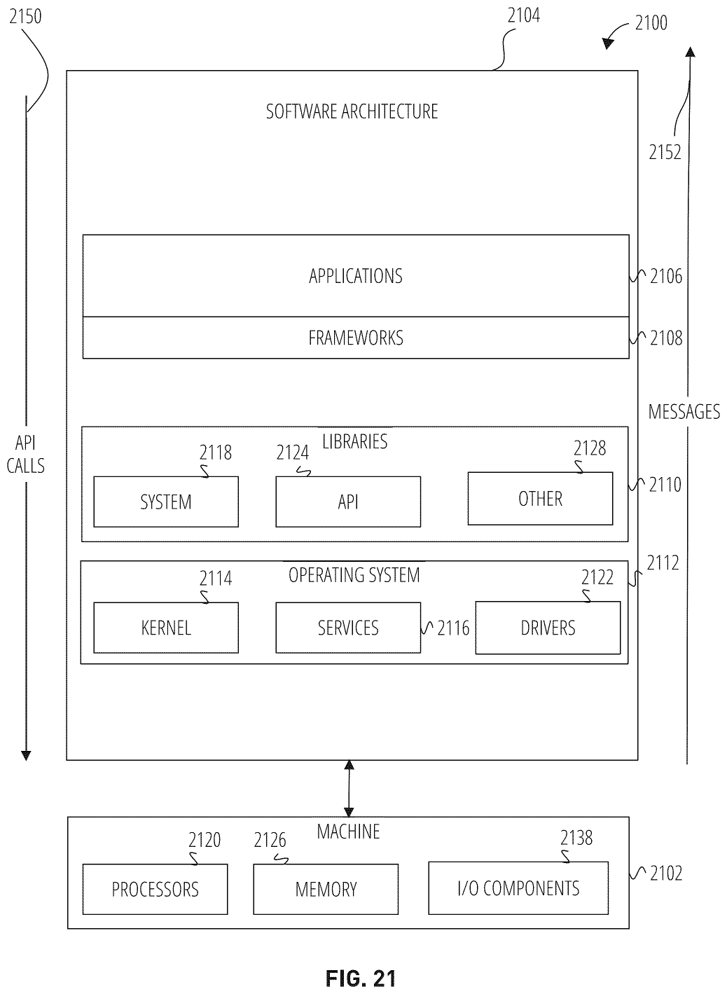

FIG. 21 is a block diagram 2100 illustrating a software architecture 2104, which can be installed on any one or more of the devices described herein. The software architecture 2104 is supported by hardware such as a machine 2102 that includes processors 2120, memory 2126, and I/O components 2138. In this example, the software architecture 2104 can be conceptualized as a stack of layers, where each layer provides a particular functionality. The software architecture 2104 includes layers such as an operating system 2112, libraries 2110, frameworks 2108, and applications 2106. Operationally, the applications 2106 invoke API calls 2150 through the software stack and receive messages 2152 in response to the API calls 2150.

The operating system 2112 manages hardware resources and provides common services. The operating system 2112 includes, for example, a kernel 2114, services 2116, and drivers 2122. The kernel 2114 acts as an abstraction layer between the hardware and the other software layers. For example, the kernel 2114 provides memory management, processor management (e.g., scheduling), component management, networking, and security settings, among other functionalities. The services 2116 can provide other common services for the other software layers. The drivers 2122 are responsible for controlling or interfacing with the underlying hardware. For instance, the drivers 2122 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 2110 provide a common low-level infrastructure used by the applications 2106. The libraries 2110 can include system libraries 2118 (e.g., C standard library) that provide functions such as memory allocation functions, string manipulation functions, mathematic functions, and the like. In addition, the libraries 2110 can include API libraries 2124 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 2110 can also include a wide variety of other libraries 2128 to provide many other APIs to the applications 2106.

The frameworks 2108 provide a common high-level infrastructure that is used by the applications 2106. For example, the frameworks 2108 provide various graphical user interface (GUI) functions, high-level resource management, and high-level location services. The frameworks 2108 can provide a broad spectrum of other APIs that can be used by the applications 2106, some of which may be specific to a particular operating system or platform.

In an example, the applications 2106 may include a broad assortment of applications, such as an application that implements one or more features of various example embodiments. The applications 2106 are programs that execute functions defined in the programs. Various programming languages can be employed to create one or more of the applications 2106, structured in a variety of manners, such as object-oriented programming languages (e.g., Objective-C, Java, or C++) or procedural programming languages (e.g., C or assembly language). In a specific example, a given application (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, a given application can invoke the API calls 2150 provided by the operating system 2112 to facilitate functionality described herein.

Described implementations of the subject matter can include one or more features, alone or in combination as illustrated below by way of examples.

Example 1 is a system comprising: a processor; and a memory storing instructions that, when executed by the processor, cause the system to perform operations comprising: detecting a payment-related event in association with a geographical location of a vehicle based on a set of vehicle sensors of the vehicle, the set of vehicle sensors comprising a camera that generates a digital image and a geospatial positioning system (GPS) unit that provides the geographical location, the detecting of the payment-related event using a machine learning model trained to recognize in the digital image one or more objects associated with the payment-related event; and in response to detecting the payment-related event, handling an electronic payment associated with the payment-related event based on data provided by at least one vehicle sensor of the set of vehicle sensors, the handling of the electronic payment comprising: using the in-vehicle digital wallet to make the electronic payment; and using a blockchain-based ledger to record the electronic payment

In Example 2, the subject matter of Example 1 includes, wherein the detecting of the payment-related event comprises: recording at least one of the data or an object detection result associated with the payment-related event in the in-vehicle digital wallet.

In Example 3, the subject matter of Examples 1-2 includes, wherein the payment-related event relates to one of a vehicle toll gate, vehicle parking, or a vehicle traffic violation.

In Example 4, the subject matter of Examples 1-3 includes, wherein the payment-related event comprises the vehicle traveling in a High Occupancy Vehicle (HOV) lane while the vehicle lacks eligibility, and wherein the detecting of the payment-related event comprises: using the camera of the set of vehicle sensors to detect that the vehicle is traveling the HOV lane; and in response to detecting that the vehicle is traveling the HOV lane: using a seat occupancy sensor of the vehicle to determine a number of passengers in the vehicle; verifying eligibility of the vehicle in the HOV lane based on the number of passengers; and detecting the payment-related event in response to the vehicle failing eligibility in the HOV lane.

In Example 5, the subject matter of Examples 1-4 includes, wherein the payment-related event comprises the vehicle parking in a paid parking space, wherein the detecting of the payment-related event comprises using at least one of the GPS and the camera to detect that the vehicle is occupying an exact location of the paid parking space, and wherein the handling of the electronic payment associated with the payment-related event based on the data comprises: using at least one of a gear position indicator of the vehicle or a speedometer of the vehicle to determine a parking duration of the vehicle in the paid parking space; and determining a fee calculation for the electronic payment based on the parking duration.

In Example 6, the subject matter of Examples 1-5 includes, wherein the handling of the electronic payment associated with the payment-related event based on the data comprises: while there is a loss of connectivity with the blockchain-based ledger, recording a negative balance in the in-vehicle digital wallet in response to sufficient funds not being available in the in-vehicle digital wallet for performing the electronic payment, the operations comprising synchronizing transaction data stored in the in-vehicle digital wallet with the blockchain-based ledger upon restoration of connectivity with the blockchain-based ledger.

In Example 7, the subject matter of Examples 1-6 includes, wherein the payment-related event comprises the vehicle traveling through a toll gate, and wherein the detecting of the payment-related event comprises: using at least one of the GPS and the camera to detect the toll gate, the using of the camera to detect toll gate comprises using the machine learning model to detect the toll gate, the machine learning model being trained to detect one or more unique characteristics of one or more toll gates, the handling of the electronic payment associated with the payment-related event based on the data comprising automatically initiating the electronic payment from the in-vehicle digital wallet in response to detection of the toll gate.

In Example 8, the subject matter of Examples 1-7 includes, wherein the electronic payment is a first electronic payment, and wherein the operations comprise: handling a second electronic payment for a subscription to a feature of the vehicle based on usage data of the feature collected by at least one vehicle sensor of the vehicle.

In Example 9, the subject matter of Examples 1-8 includes, wherein the payment-related event comprises a vehicle infraction, and wherein the detecting of the payment-related event comprises: detecting the vehicle infraction based on sensor data collected from the set of vehicle sensors, the handling of the electronic payment associated with the payment-related event based on the data comprising processing a fine associated with the vehicle infraction.

In Example 10, the subject matter of Examples 1-9 includes, wherein the operations comprise: logging a history of the vehicle in the in-vehicle digital wallet, the history comprising information regarding at least one of repair or charging of the vehicle.

In Example 11, the subject matter of Examples 1-10 includes, wherein the operations comprise: sharing payment evidence from the blockchain-based ledger with a law enforcer.

In Example 12, the subject matter of Examples 1-11 includes, wherein the in-vehicle digital wallet is implemented using a tamper-proof storage system configured to ensure security and integrity of stored data using at least one of: an Oblivious Pseudo-Random Function (PRF) to generate a master key for encrypting stored data on the tamper-proof storage system; a secure computation environment that provides an isolated execution space on the tamper proof storage system; or a secure element hardware chip of the tamper-proof storage system.

In Example 13, the subject matter of Examples 1-12 includes, wherein the in-vehicle digital wallet comprises a sensor data authorization component that uses use a set of statistical models to at least detect fraudulent activity or detecting an anomaly or discrepancy that indicates tampering or failure of a vehicle sensor.

In Example 14, the subject matter of Example 13 includes, wherein the set of statistical models comprises: a statistical model for cumulative correlation of location and sensor data inputs from multiple vehicle sensors to detect fraudulent activity.

In Example 15, the subject matter of Example 14 includes, wherein the operations comprise: storing a result of a cumulative correlation analysis in the blockchain-based ledger as part of the vehicle's verifiable activity history.

In Example 16, the subject matter of Examples 13-15 includes, wherein the set of statistical models comprises: a statistical model for trend analysis of distance traveled using a measure of the ordinal association between two measured quantities to validate consistency of sensor data, the validation being used to detect the anomaly or discrepancy that indicates tampering or failure of the vehicle sensor.

In Example 17, the subject matter of Example 16 includes, wherein the operations comprise: storing a result of a trend analysis in the blockchain-based ledger as part of the vehicle's verifiable activity history.

In Example 18, the subject matter of Examples 1-17 includes, wherein the operations comprise: hashing sensor data, activity histories, other additional data, or some combination thereof together with commitments and proofs using Fiat-Shamir transform in a Zero Knowledge Proof scheme to ensure data integrity, and providing the hashed sensor data to a third party as proof of the sensor data.

Example 19 is a method to implement any of Examples 1-18.

Example 20 is at least one machine storage medium comprising instructions that, when executed by a processor, cause the processor to perform operations to implement any of Examples 1-18.

“Carrier signal” refers to any intangible medium that is capable of storing, encoding, or carrying instructions for execution by the machine, and includes digital or analog communications signals or other intangible media to facilitate communication of such instructions. Instructions may be transmitted or received over a network using a transmission medium via a network interface device.

“Client device” refers to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors 2004 or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” refers to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers to a tangible medium that is capable of storing, encoding, or carrying the instructions for execution by a machine.

“Signal medium” refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to some example embodiments, various modifications and changes may be made to these embodiments without departing from the broader scope of embodiments of the present disclosure.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The detailed description, therefore, is not to be taken in a limiting sense, and the scope of various example embodiments is defined only by the appended claims, along with the full range of equivalents to which such claims are entitled.

As used herein, the term “or” may be construed in either an inclusive or exclusive sense. The terms “a” or “an” should be read as meaning “at least one,” “one or more,” or the like. The use of words and phrases such as “one or more,” “at least,” “but not limited to,” or other like phrases shall not be read to mean that the narrower case is intended or required in instances where such broadening phrases may be absent.

Boundaries between various resources, operations, components, engines, and data stores are somewhat arbitrary, and particular operations are illustrated in a context of specific illustrative configurations. Other allocations of functionality are envisioned and may fall within a scope of various example embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The description above includes systems, methods, devices, instructions, and computer media (e.g., computing machine program products) that embody illustrative embodiments of the disclosure. In the description, for the purposes of explanation, numerous specific details are set forth in order to provide an understanding of various example embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

What is claimed is:

1. A system comprising:
an in-vehicle digital wallet;
a processor; and
a memory storing instructions that, when executed by the processor, cause the system to perform operations comprising:
detecting a payment-related event in association with a geographical location of a vehicle based on a set of vehicle sensors of the vehicle, the set of vehicle sensors comprising a camera that generates a digital image and a geospatial positioning system (GPS) unit that provides the geographical location, the detecting of the payment-related event using a machine learning model trained to recognize in the digital image one or more objects associated with the payment-related event; and
in response to detecting the payment-related event, handling an electronic payment associated with the payment-related event based on data provided by at least one vehicle sensor of the set of vehicle sensors, the handling of the electronic payment comprising:
using the in-vehicle digital wallet to make the electronic payment; and
using a blockchain-based ledger to record the electronic payment.

2. The system of claim 1, wherein the detecting of the payment-related event comprises:
recording at least one of the data or an object detection result associated with the payment-related event in the in-vehicle digital wallet.

3. The system of claim 1, wherein the payment-related event relates to one of a vehicle toll gate, vehicle parking, or a vehicle traffic violation.

4. The system of claim 1, wherein the payment-related event comprises the vehicle traveling in a High Occupancy Vehicle (HOV) lane while the vehicle lacks eligibility, and wherein the detecting of the payment-related event comprises:
using the camera of the set of vehicle sensors to detect that the vehicle is traveling the HOV lane; and
in response to detecting that the vehicle is traveling the HOV lane:
using a seat occupancy sensor of the vehicle to determine a number of passengers in the vehicle;
verifying eligibility of the vehicle in the HOV lane based on the number of passengers; and
detecting the payment-related event in response to the vehicle failing eligibility in the HOV lane.

5. The system of claim 1, wherein the payment-related event comprises the vehicle parking in a paid parking space, wherein the detecting of the payment-related event comprises using at least one of the GPS and the camera to detect that the vehicle is occupying an exact location of the paid parking space, and wherein the handling of the electronic payment associated with the payment-related event based on the data comprises:
using at least one of a gear position indicator of the vehicle or a speedometer of the vehicle to determine a parking duration of the vehicle in the paid parking space; and
determining a fee calculation for the electronic payment based on the parking duration.

6. The system of claim 1, wherein the handling of the electronic payment associated with the payment-related event based on the data comprises:
while there is a loss of connectivity with the blockchain-based ledger, recording a negative balance in the in-vehicle digital wallet in response to sufficient funds not being available in the in-vehicle digital wallet for performing the electronic payment, the operations comprising synchronizing transaction data stored in the in-vehicle digital wallet with the blockchain-based ledger upon restoration of connectivity with the blockchain-based ledger.

7. The system of claim 1, wherein the payment-related event comprises the vehicle traveling through a toll gate, and wherein the detecting of the payment-related event comprises:
using at least one of the GPS and the camera to detect the toll gate, the using of the camera to detect toll gate comprises using the machine learning model to detect the toll gate, the machine learning model being trained to detect one or more unique characteristics of one or more toll gates, the handling of the electronic payment associated with the payment-related event based on the data comprising automatically initiating the electronic payment from the in-vehicle digital wallet in response to detection of the toll gate.

8. The system of claim 1, wherein the electronic payment is a first electronic payment, and wherein the operations comprise:
handling a second electronic payment for a subscription to a feature of the vehicle based on usage data of the feature collected by at least one vehicle sensor of the vehicle.

9. The system of claim 1, wherein the payment-related event comprises a vehicle infraction, and wherein the detecting of the payment-related event comprises:
detecting the vehicle infraction based on sensor data collected from the set of vehicle sensors, the handling of the electronic payment associated with the payment-related event based on the data comprising processing a fine associated with the vehicle infraction.

10. The system of claim 1, wherein the operations comprise:
logging a history of the vehicle in the in-vehicle digital wallet, the history comprising information regarding at least one of repair or charging of the vehicle.

11. The system of claim 1, wherein the operations comprise:
sharing payment evidence from the blockchain-based ledger with a law enforcer.

12. The system of claim 1, wherein the in-vehicle digital wallet is implemented using a tamper-proof storage system configured to ensure security and integrity of stored data using at least one of:
an Oblivious Pseudo-Random Function (PRF) to generate a master key for encrypting stored data on the tamper-proof storage system;
a secure computation environment that provides an isolated execution space on the tamper proof storage system; or
a secure element hardware chip of the tamper-proof storage system.

13. The system of claim 1, wherein the in-vehicle digital wallet comprises a sensor data authorization component that uses use a set of statistical models to at least detect fraudulent activity or detecting an anomaly or discrepancy that indicates tampering or failure of a vehicle sensor.

14. The system of claim 13, wherein the set of statistical models comprises:
a statistical model for cumulative correlation of location and sensor data inputs from multiple vehicle sensors to detect fraudulent activity.

15. The system of claim 14, wherein the operations comprise:
storing a result of a cumulative correlation analysis in the blockchain-based ledger as part of the vehicle's verifiable activity history.

16. The system of claim 13, wherein the set of statistical models comprises:
a statistical model for trend analysis of distance traveled using a measure of the ordinal association between two measured quantities to validate consistency of sensor data, the validation being used to detect the anomaly or discrepancy that indicates tampering or failure of the vehicle sensor.

17. The system of claim 16, wherein the operations comprise:
storing a result of a trend analysis in the blockchain-based ledger as part of the vehicle's verifiable activity history.

18. The system of claim 1, wherein the operations comprise:
hashing sensor data, activity histories, other additional data, or some combination thereof together with commitments and proofs using Fiat-Shamir transform in a Zero Knowledge Proof scheme to ensure data integrity; and
providing the hashed sensor data to a third party as proof of the sensor data.

19. A machine storage medium including instructions that when executed by a processor, cause the processor to perform operations comprising:
detecting a payment-related event in association with a geographical location of a vehicle based on a set of vehicle sensors of the vehicle, the set of vehicle sensors comprising a camera that generates a digital image and a geospatial positioning system (GPS) unit that provides the geographical location, the detecting of the payment-related event using a machine learning model trained to recognize in the digital image one or more objects associated with the payment-related event; and
in response to detecting the payment-related event, handling an electronic payment associated with the payment-related event based on data provided by at least one vehicle sensor of the set of vehicle sensors, the handling of the electronic payment comprising:
using an in-vehicle digital wallet of the vehicle to make the electronic payment; and
using a blockchain-based ledger to record the electronic payment.

20. A method comprising:
detecting, by one or more processors, a payment-related event in association with a geographical location of a vehicle based on a set of vehicle sensors of the vehicle, the set of vehicle sensors comprising a camera that generates a digital image and a geospatial positioning system (GPS) unit that provides the geographical location, the detecting of the payment-related event using a machine learning model trained to recognize in the digital image one or more objects associated with the payment-related event; and
in response to detecting the payment-related event, handling, by the one or more processors, an electronic payment associated with the payment-related event based on data provided by at least one vehicle sensor of the set of vehicle sensors, the handling of the electronic payment comprising:
using an in-vehicle digital wallet of the vehicle to make the electronic payment; and
using a blockchain-based ledger to record the electronic payment.
